(19) United States
(12) Patent Application Publication
(10) Pub. No.: US 2025/0296633 A1
(43) Pub. Date: Sep. 25, 2025

(54) VEHICLE

(71) Applicant: Polaris Industries Inc., Medina, MN (US)

(72) Inventors: John B. Pircon, Wyoming, MN (US); Alex R. Scheuerell, Wyoming, MN (US); Dennis J. Lutz, Wyoming, MN (US); Molly C. Steinberg, Wyoming, MN (US); Jacob M. Olson, Wyoming, MN (US); Andrew T. Ives, Wyoming, MN (US); Joshua A. Rasa, Fridley, MN (US)

(73) Assignee: Polaris Industries Inc., Medina, MN (US)

(21) Appl. No.: 19/081,396

(22) Filed: Mar. 17, 2025

Related U.S. Application Data
(60) Provisional application No. 63/567,686, filed on Mar. 20, 2024.

(51) Int. Cl. B62D 23/00

(52) U.S. Cl. CPC B62D 23/005

(57) ABSTRACT

A vehicle includes ground engaging members supporting a frame. The frame includes a front and rear frame portion, and the front frame portion includes a first upstanding frame member a second upstanding frame member. A prime mover is coupled to at least one ground engaging member and a drive member is coupled between the prime mover and the at least one ground engaging member. A first suspension is coupled intermediate the frame and the at least one ground engaging member and a second suspension is coupled intermediate the frame and a second ground engaging member. A third suspension is coupled between the first and second suspension. The first suspension is supported by the first upstanding member, the second suspension is supported by the second upstanding member, and each of the third suspension and the drive member are supported by each of the first and second upstanding members.

### CROSS-REFERENCE TO RELATED APPLICATIONS

The present application claims the benefit of U.S. Provisional Patent Application No. 63/567,686, filed Mar. 20, 2024, the entire disclosure of which is incorporated herein by reference.

The present disclosure relates to U.S. patent application Ser. No. 18/405,756, filed Jan. 5, 2024, titled VEHICLE, attorney docket no. PLR-15-30588.05P-US, the entire disclosure of which is expressly incorporated by reference herein.

### FIELD OF THE DISCLOSURE

The present disclosure relates to off-road vehicles (e.g., utility vehicles or “UTVs”) and, more particularly, to features for an off-road vehicle designed for high-speed and/or high-performance operation.

### BACKGROUND OF THE DISCLOSURE

Utility and recreational vehicles often face constraints not otherwise known by larger vehicles including vehicle range, weight, terrain traversed, and others. The present disclosure reflects a vehicle frame, suspension, and other vehicle improvements.

### SUMMARY OF THE DISCLOSURE

In embodiments of the present disclosure, a vehicle is provided. The vehicle includes a plurality of ground engaging members and a frame supported by the plurality of ground engaging members. The frame includes a front frame portion and a rear frame portion, and the front frame portion comprises a first generally upstanding frame member a second generally upstanding frame member laterally offset from the first generally upstanding frame member. A powertrain is supported by the frame, and the powertrain includes a prime mover operably coupled to at least one ground engaging member of the plurality of ground engaging members and a drive member operably coupled intermediate the prime mover and the at least one ground engaging member, and the drive member is supported by the front frame portion. A first suspension is coupled intermediate the frame and the at least one ground engaging member a second suspension is coupled intermediate the frame and a second ground engaging member of the plurality of ground engaging members, and a third suspension is coupled between the first suspension and the second suspension. Further, the first suspension is supported by the first generally upstanding frame member, the second suspension is supported by the second generally upstanding frame member, the drive member is supported by each of the first generally upstanding frame member and the second generally upstanding frame member, and the third suspension is supported by each of the first generally upstanding frame member and the second generally upstanding frame member.

In embodiments of the present disclosure, the vehicle includes a sleeve coupled to the first generally upstanding frame member, and the third suspension extends through the sleeve.

In embodiments of the present disclosure, the sleeve is coupled to each of the first generally upstanding frame member and the second generally upstanding frame member.

In embodiments of the present disclosure, the third suspension includes a stabilizer bar extending through the sleeve.

In embodiments of the present disclosure, the sleeve is fixedly coupled to each of the first generally upstanding frame member and the second generally upstanding frame member.

In embodiments of the present disclosure, the first generally upstanding member includes a recess and the first suspension sits within the recess, and the recess is positioned vertically lower than the sleeve.

In embodiments of the present disclosure, the frame further includes a third generally upstanding frame member and a fourth generally upstanding frame member, and the third generally upstanding frame member is fixedly coupled to an upper portion of the first generally upstanding frame member and the fourth generally upstanding frame member is fixedly coupled to an upper portion of the second generally upstanding frame member.

In embodiments, the vehicle includes a bumper operably coupled to each of the first generally upstanding frame member and the second generally upstanding frame member.

In yet another embodiment of the present disclosure, a vehicle is provided. The vehicle includes a plurality of ground engaging members and a frame supported by the plurality of ground engaging members. The frame includes a front frame portion, the front frame portion including a first upstanding member and a second upstanding member laterally offset from the first upstanding member. A first frame member extends rearwardly from the first upstanding member and a second frame member extends rearwardly from the second upstanding member, and a third frame member extends between the first frame member and the second frame member. A powertrain is supported by the frame, and the powertrain includes a prime mover operably coupled to at least one ground engaging member of the plurality of ground engaging members and a drive member is operably coupled between the prime mover and the at least one ground engaging member. Further, a steering assembly is supported by the frame, and the steering assembly is operably coupled to a first ground engaging member of the plurality of ground engaging members. Further, the drive member is supported by each of the first upstanding member, the second upstanding member and the third frame member, and the steering assembly is supported by the third frame member.

In embodiments, the drive member includes a first mounting collar and a second mounting collar, and the third frame member includes a first mounting portion and a second mounting portion. Further, the first mounting collar is coupled between the first upstanding member and the second upstanding member and the second mounting collar is coupled between the first mounting portion and the second mounting portion.

In embodiments, the third frame member is a collar that surrounds at least a portion of the drive member.

In embodiments, the steering assembly includes a steering rack, and the steering rack is supported by the frame through the third frame member.

In embodiments, the steering rack is positioned rearwardly of the drive member.

In embodiments, the vehicle includes a suspension member operably coupled between the frame and the first ground engaging member, and the suspension member is operably coupled to the first upstanding member.

In embodiments, the vehicle includes a suspension member operably coupled between the frame and the first ground engaging member, and the suspension member is operably coupled to the first upstanding member.

In embodiments, the vehicle includes a bracket coupled to the frame, the bracket positioned rearward of the first upstanding member, and the suspension member is operably coupled to each of the first upstanding member and the bracket.

In embodiments, the steering rack is positioned longitudinally forward of the bracket.

In embodiments, the suspension member is a first suspension member, and a second suspension member is operably coupled between the frame and a second ground engaging member. Further, a stabilizer bar assembly is coupled to each of the first suspension member and the second suspension member, and the stabilizer bar assembly is supported by each of the first upstanding member and the second upstanding member.

In embodiments, a sleeve is operably coupled to each of the first upstanding member and the second upstanding member, and a member of the stabilizer bar assembly extends through the sleeve.

In yet another embodiment of the present disclosure, a vehicle is provided. The vehicle includes a plurality of ground engaging members and a frame supported by the plurality of ground engaging members. The frame includes a lower frame portion, a first frame member positioned vertically above the lower frame portion, and a second frame member coupled to the first frame member at a first mounting point and extending generally downwardly from the first frame member. Further, a third frame member is coupled to the first frame member at a second mounting point and extending generally downwardly from the first frame member, the third frame member coupled with the second frame member to form an X shape. Further, a fourth frame member is coupled to the first frame member at a third mounting point forward of the first mounting point and extending generally downwardly, and the fourth frame member is coupled with the second frame member. Further, a fifth frame member is coupled to the first frame member at a fourth mounting point forward of the first mounting point and extending generally downwardly, and the fifth frame member is coupled with the third frame member.

In embodiments, the fourth frame member is coupled to the lower frame portion and the fifth frame member is coupled to the lower frame portion.

In embodiments, the frame further includes a sixth frame member coupled to the first frame member and extending generally downwardly, a seventh frame member coupled to the first frame member and extending generally downwardly, and the second frame member is coupled between the first frame member and the sixth frame member, and the third frame member is coupled between the first frame member and the seventh frame member.

In embodiments, the second frame member includes a first portion and a second portion, and the first portion is coupled to a first side of the third frame member and the second portion is coupled to a second side of the third frame member opposite the first side.

In embodiments, one of the second frame member and the fourth frame member includes a scalloped portion and the other of the second frame member and the fourth frame member sits within the scalloped portion.

In yet another embodiment of the present disclosure, a vehicle is provided. The vehicle includes a plurality of ground engaging members and a frame supported by the plurality of ground engaging members, and the frame extends along a vehicle centerline. A first suspension member is operably coupled between the frame and a first ground engaging member of the plurality of ground engaging members, and a first shock absorber coupled between the frame at a first mounting point and the second suspension member at a second mounting point. Further, a second suspension member is operably coupled between the frame and a second ground engaging member of the plurality of ground engaging members, and a second shock absorber is coupled between the frame at a third mounting point and the second suspension member at a fourth mounting point. Further, a stabilizer bar assembly coupled between the first suspension member and the second suspension member. The stabilizer bar assembly includes a first mounting member coupled to the frame on a first side of the vehicle centerline and positioned laterally outwardly relative to the first mounting point. The stabilizer bar assembly also includes a second mounting member coupled to the frame on a second side of the vehicle centerline opposite the first side and positioned laterally outwardly relative to the third mounting point. The stabilizer bar assembly further includes a stabilizer bar supported by the first mounting member and the second mounting member, and the stabilizer bar is cantilevered between the first mounting member and the second mounting member.

In embodiments, the first mounting member is positioned laterally inwardly relative to the second mounting point and the second mounting member is positioned laterally inwardly relative to the fourth mounting point.

In embodiments, the stabilizer bar defines a first portion defining a first wall thickness and a second portion defining a second wall thickness, and the second wall thickness is less than the first wall thickness.

In embodiments, the second portion is positioned adjacent a lateral end of the stabilizer bar.

In embodiments, the stabilizer bar defines a first portion defining a first outer diameter and a second portion defining a second outer diameter, and the first outer diameter is less than the second outer diameter.

In embodiments, the second portion is positioned adjacent the first mounting member.

In embodiments, the first portion is positioned laterally intermediate the first mounting member and the second mounting member.

### BRIEF DESCRIPTION OF THE DRAWINGS

FIG. 1 is a front left perspective view of a vehicle of the present disclosure;

FIG. 2 is a right rear perspective view of the vehicle of FIG. 1;

FIG. 3 is a left side view of the vehicle of FIG. 1;

FIG. 4 is a right side view of the vehicle of FIG. 1;

FIG. 5 is a top view of the vehicle of FIG. 1;

FIG. 6 is a bottom view of the vehicle of FIG. 1;

FIG. 7 is a front view of the vehicle of FIG. 1;

FIG. 8 is a rear view of the vehicle of FIG. 1;

FIG. 9 is a front left perspective view of a frame of a vehicle of the present disclosure;

FIG. 10 is a front left exploded view of the frame of FIG. 9;

FIG. 11 is a front left perspective view of a frame of a vehicle of the present disclosure;

FIG. 12 is a right rear view of the frame of FIG. 11;

FIG. 13 is a left side view of the frame of FIG. 11;

FIG. 14 is a right side view of the frame of FIG. 11;

FIG. 15 is a top view of the frame of FIG. 11;

FIG. 16 is a front view of the frame of FIG. 11;

FIG. 17 is a diagrammatic view of a powertrain of the present disclosure;

FIG. 18 is a front left perspective view of a front drive area of the present disclosure

FIG. 19 is an exploded view of the front drive area of FIG. 18;

FIG. 20A is a front left perspective view of a front suspension of the present disclosure;

FIG. 20B is a top view of the front suspension of FIG. 20A;

FIG. 21A is a left view of a steering assembly of the present disclosure showing a steering column in an uncompressed state;

FIG. 21B is a left view of a steering assembly of FIG. 21A showing a steering column in a compressed state

FIG. 22 is a perspective view of a steering column of the steering assembly of FIG. 21A;

FIG. 23 is a perspective view of a portion of a front frame of the frame of FIG. 9;

FIG. 24 is an exploded view of the portion of a front frame of FIG. 23;

FIG. 25A is a perspective view of a suspension arm of the present disclosure;

FIG. 25B is an exploded view of a joint of the suspension arm of FIG. 25A;

FIG. 26 is a diagrammatic view of a braking assembly of the present disclosure;

FIG. 27A is a perspective view of a brake assembly mounting to a vehicle of the present disclosure;

FIG. 27B is an exploded view of the brake assembly of FIG. 27A;

FIG. 28 is a perspective view of a door ring of the frame of FIG. 9;

FIG. 29 is an exploded view of the door ring of FIG. 28;

FIG. 30 is a perspective view of a body panel mounting assembly of the present disclosure;

FIG. 31 is an exploded view of the body panel mounting assembly of FIG. 30;

FIG. 32 is a top view of a rear frame portion of the frame of FIG. 9;

FIG. 33 is a cross-section of a stabilizer bar of the present disclosure, taken along line 33-33 of FIG. 32;

FIG. 34 is a perspective view of a shock absorber of the present disclosure showing a limiter strap;

FIG. 35 is a perspective view of a mounting assembly for the shock absorber and limiter strap of FIG. 34;

FIG. 36 is a rear perspective view of a rear portion of a frame of the present disclosure;

FIG. 37 is an exploded view of the portion of the frame of FIG. 36;

FIG. 38 is a rear perspective view of a rear portion of a frame of the present disclosure;

FIG. 39 is a perspective view of a brake shield coupled to a rear suspension of the present disclosure;

FIG. 40 is an exploded view of the brake shield of FIG. 39;

FIG. 41 is a perspective view of a radiator and a light bar of the present disclosure;

FIG. 42 is an exploded view of the radiator and light bar of FIG. 41;

FIG. 43 is a rear view of a portion of an operator area of the present disclosure showing a passenger footrest and a driver footrest;

FIG. 44 is a perspective view of the portion of the operator area of FIG. 43 showing a passenger footrest and a driver footrest; and

FIG. 45 is a section view of the portion of the operator area of FIG. 43, taken along line 45-45 of FIG. 43.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

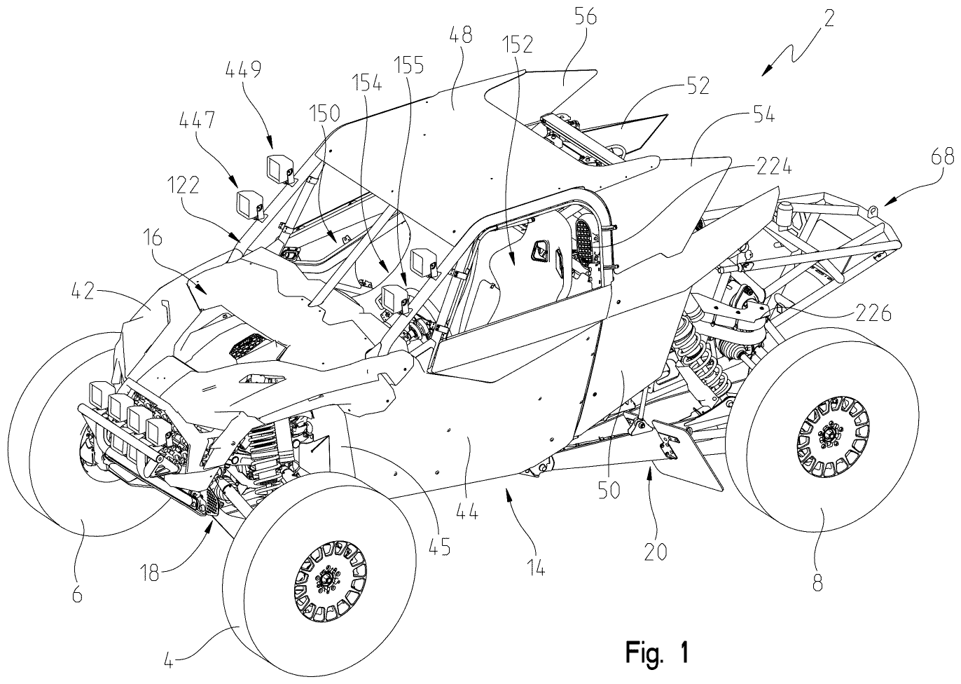

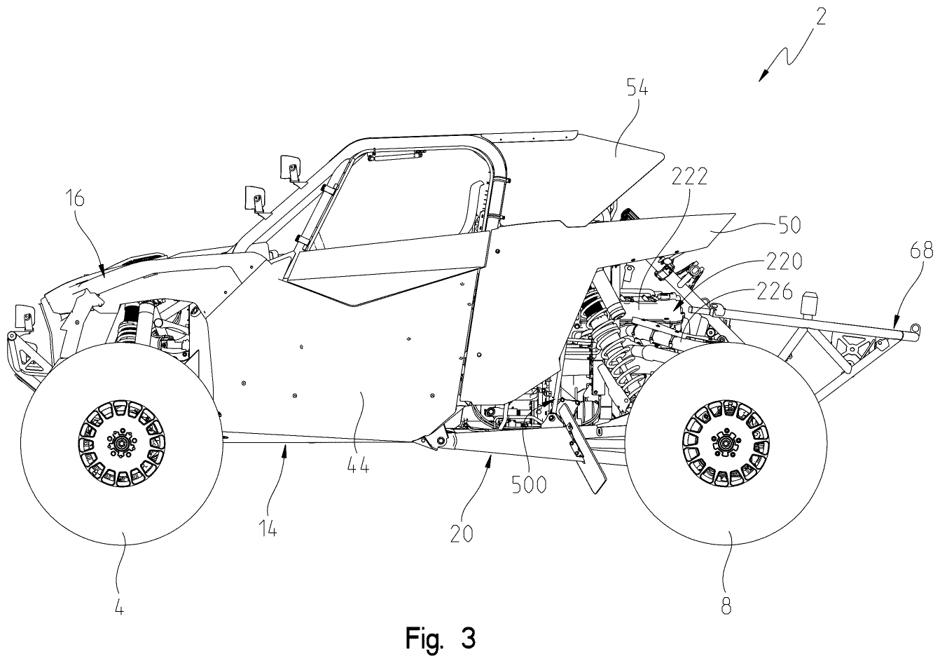

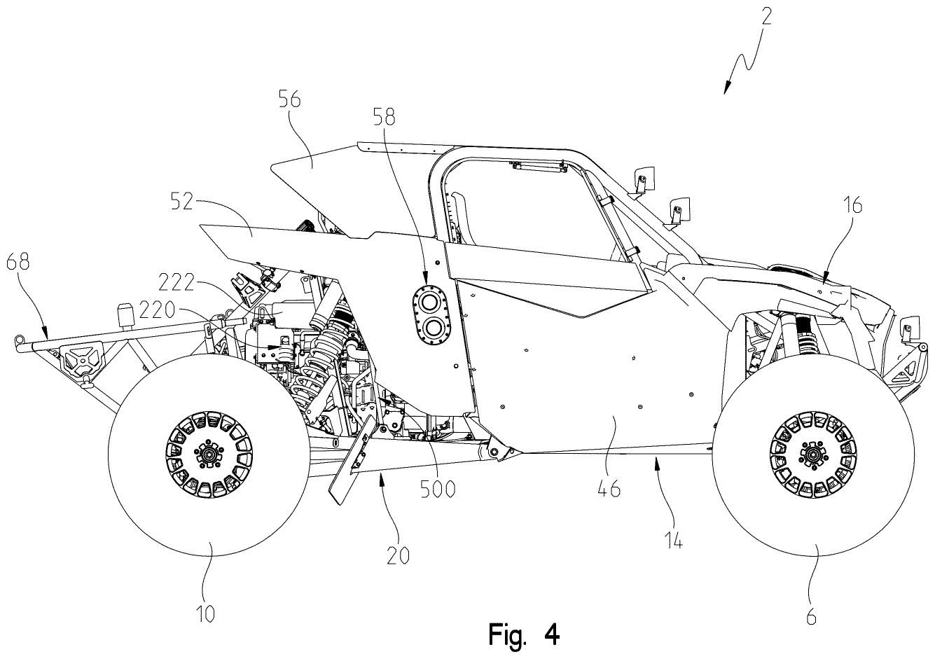

Referring now to FIGS. 1-8, a vehicle 2 includes a plurality of ground engaging members including a first or front left ground engaging member 4, a second or front right ground engaging member 6, a third or rear left ground engaging member 8, and a fourth or rear right ground engaging member 10. In embodiments, ground engaging members 4, 6, 8, 10 are wheels, and in embodiments, ground engaging member 4, 6, 8, 10 are tracks, skis, or other types of ground engaging members. Vehicle 2 includes a frame 14 supported by the plurality of ground engaging members and a body assembly 16 supported by the frame 14.

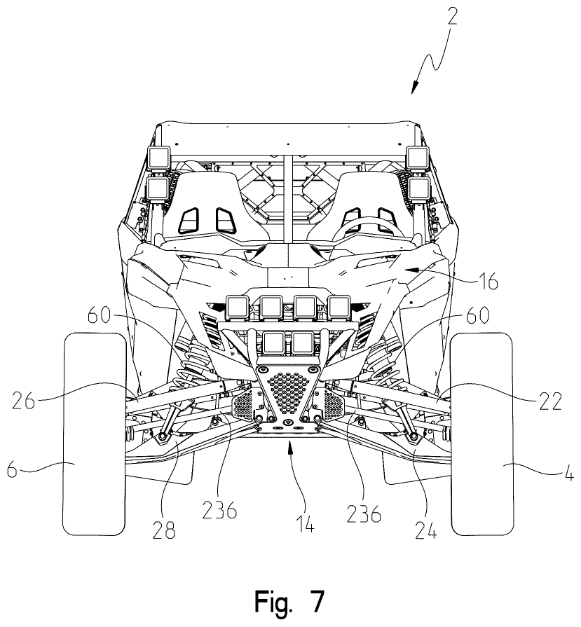

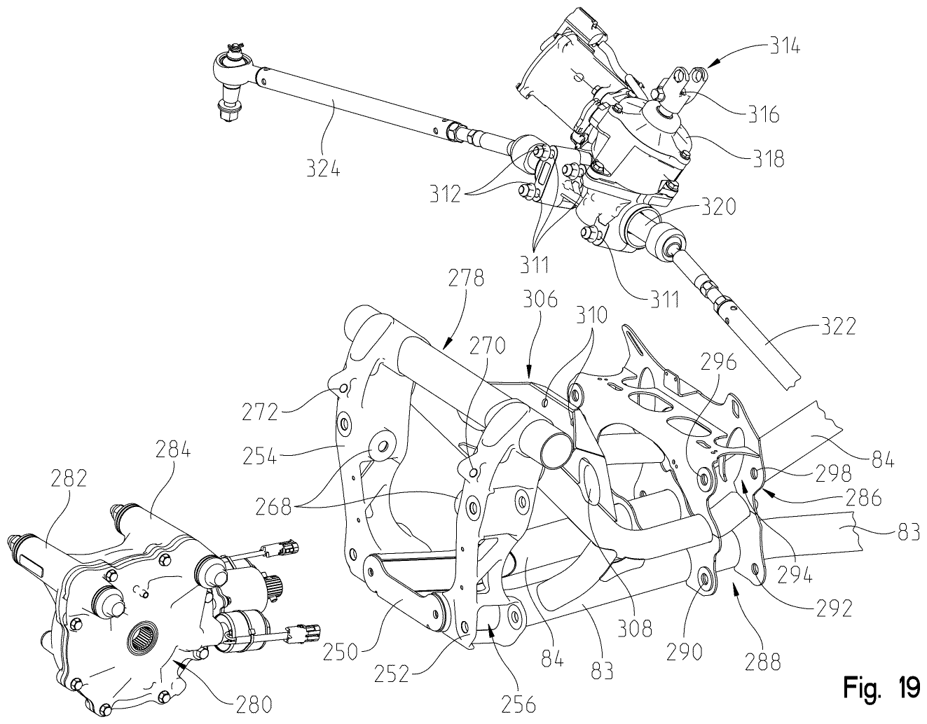

Still referring to FIGS. 1-8, vehicle 2 includes a front suspension 18 coupled between frame 14 and ground engaging members 4, 6. In embodiments, front suspension 18 is a double A-arm suspension. That is, an upper A-arm 22 (FIG. 19) and a lower A-arm 24 (FIG. 19) are coupled between frame 14 and ground engaging member 4, and an upper A-arm 26 (FIG. 19) and a lower A-arm 28 (FIG. 19) are coupled between frame 14 and ground engaging member 6. In embodiments, front suspension 18 is a strut type suspension, a modified A-arm suspension, or another type of suspension. In embodiments, a pair of shock absorbers 60 (FIG. 7) extend between frame 14 and lower A-arms 24, 28 and shock absorbers 60 dampen the movement (e.g., rotation) of A-arms 22, 24, 26, 28 (and ground engaging members 4, 6) relative to frame 14.

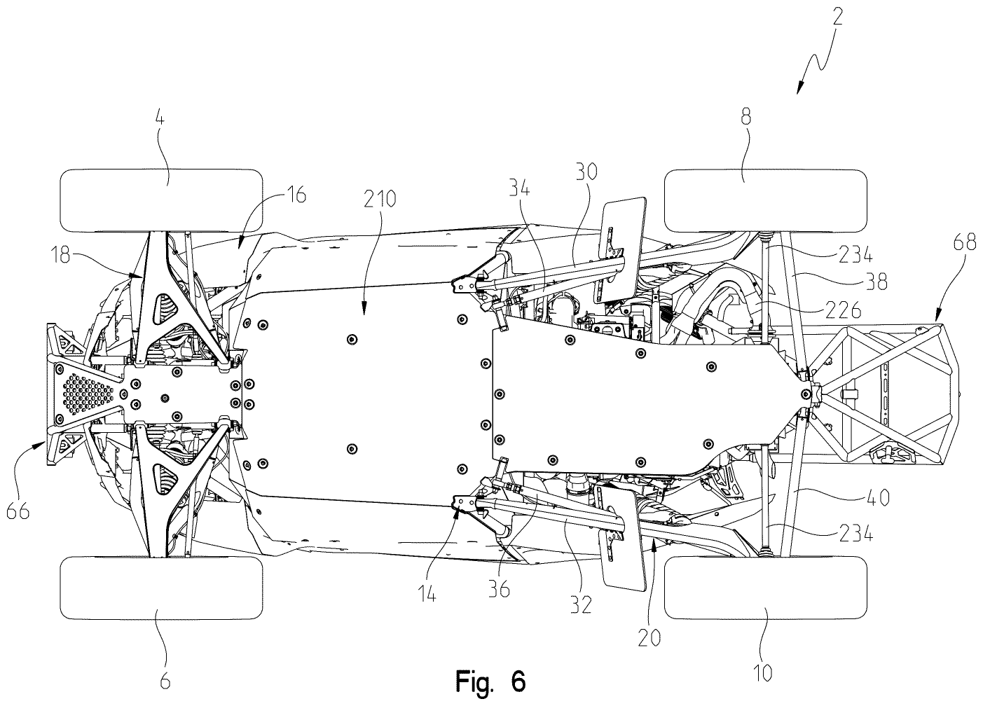

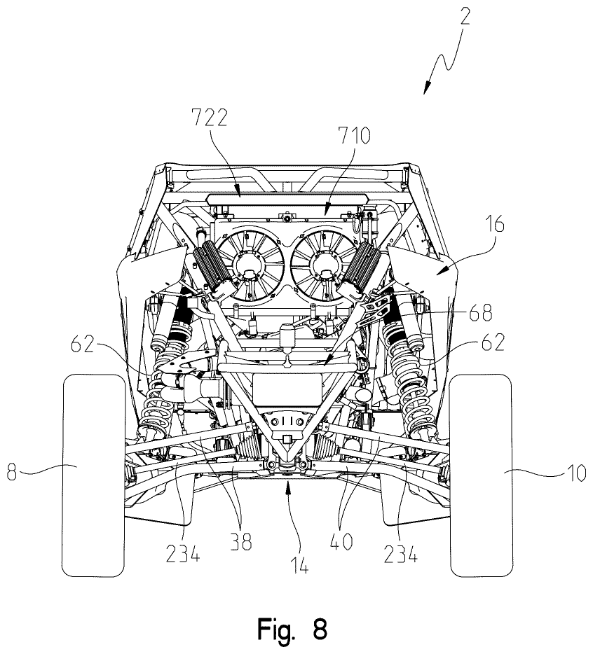

Still referring to FIGS. 1-8, vehicle 2 includes a rear suspension 20 coupled between frame 14 and ground engaging member 8, 10. In embodiments, rear suspension 20 is an independent rear suspension, such as a trailing arm suspension. That is, a first or left trailing arm 30 (FIG. 6) may be coupled between frame 14 and ground engaging member 8, and a second or right trialing arm 32 (FIG. 6) may be coupled between frame 14 and ground engaging member 10. Rear suspension 20 may include a plurality of control arms. In embodiments, rear suspension 20 includes a pair of longitudinally extending control arms 34, 36 (FIG. 6) extending between frame 14 and ground engaging members 8, 10, respectively, and a plurality of laterally extending control arms 38, 40 (FIG. 6) extending between frame 14 and ground engaging members 8, 10, respectively. In embodiments, a pair of shock absorbers 62 (FIG. 8) extend between frame 14 and trailing arms 30, 32 and shock absorbers 62 dampen the movement (e.g., rotation) of trailing arms 30, 32 (and ground engaging members 8, 10) relative to frame 14.

Referring to FIGS. 1-3, body assembly 16 includes a plurality of body panels including a hood 42, a first or driver door panel 44, a second or passenger door panel 46, a roof 48, a first or driver rear fender panel 50, a second or passenger rear fender panel 52, a third or driver upper rear fender panel 54, and a fourth or passenger upper rear fender panel 56. Any portion of body assembly 16 disclosed herein may be comprised of a polymeric material, composite material, or any material suitable for vehicle 2. In one embodiment, at least portions of body assembly 16 are comprised of a carbon-fiber material which maintains strength while reducing the weight of the overall body assembly 16. In some embodiments, the carbon fiber may be included with a layer of an aramid fiber (e.g., Kevlar). For example, body panels within an operator area (e.g., operator area 150), such as the dashboard, may be comprised of carbon fiber and an aramid fiber layer; however, any portion of any of body assembly 16 may be comprised of such materials.

In embodiments, a body panel of the plurality of body panels of body assembly 16 defines a fuel port 58. In embodiments, passenger rear fender panel 52 defines the fuel port 58. In embodiments, the fuel port 58 includes two fuel ports 58. In embodiments, fuel port(s) 58 are fluidly coupled with a fuel tank (not shown). In embodiments, vehicle 2 includes a skid plate 210 (FIG. 6) configured to conceal and/or protect vehicle 2 from an underside. In embodiments, vehicle 2 includes a front wall 45 positioned intermediate operator area.

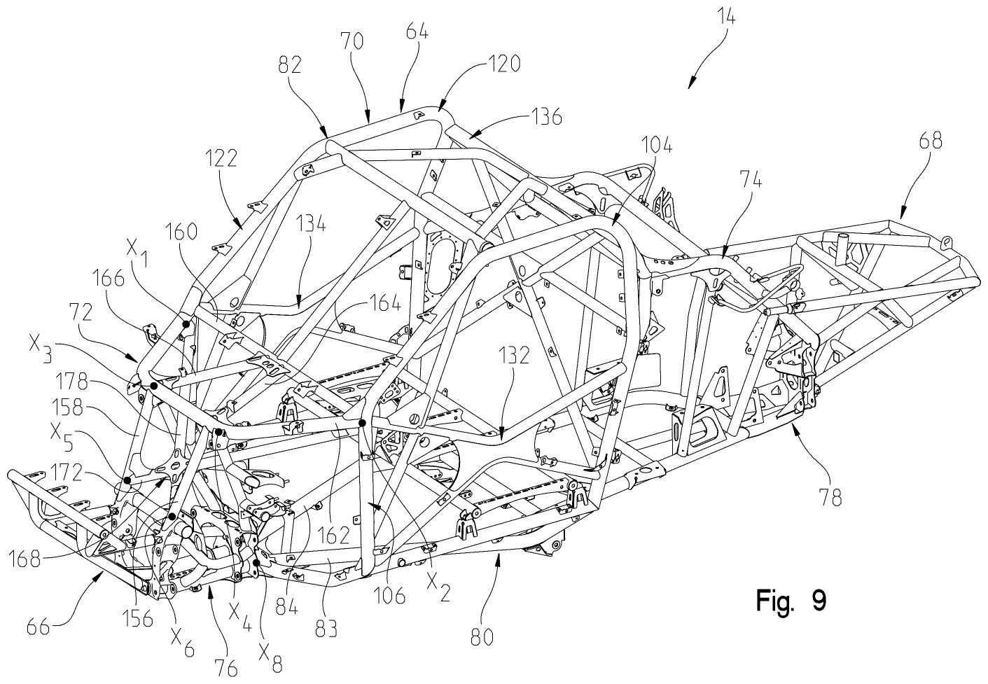

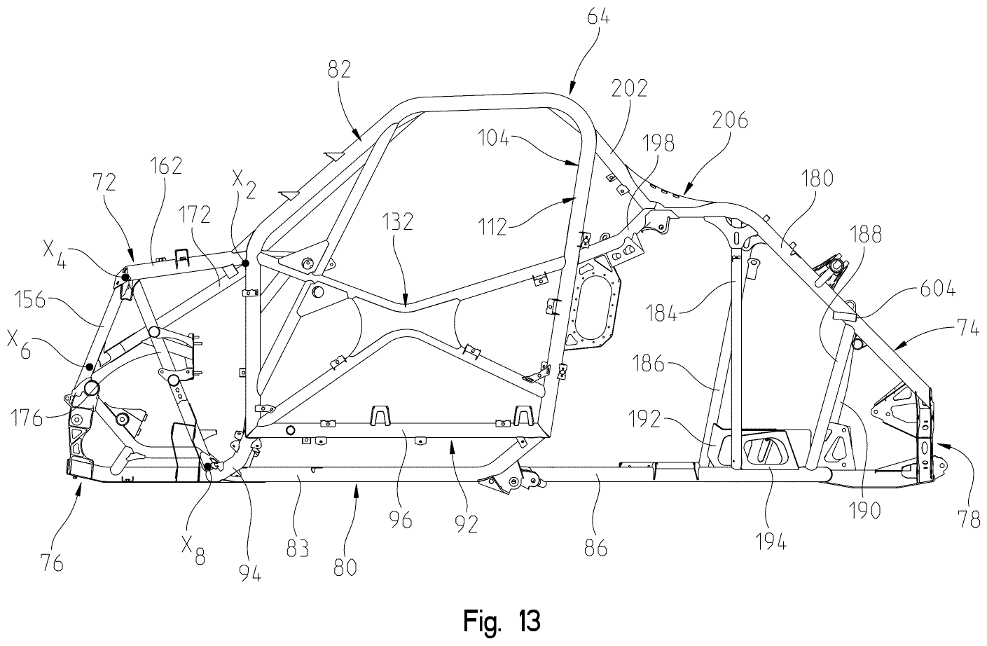

Referring to FIGS. 9-16, frame assembly 14 includes a main frame portion 64, a front bumper or front subframe 66 coupled to a front portion of main frame portion 64, and a rear bumper or rear subframe 68 coupled to a rear portion of main frame portion 64.

Referring still to FIGS. 9-16, main frame portion 64 includes a center frame portion 70, a front frame portion 72, and a rear frame portion 74. A front subassembly 76 is positioned within front frame portion 72 and a rear subassembly 78 is positioned within rear frame portion 74. Main frame portion 64 generally includes a lower frame portion 80 and an upper frame portion 82.

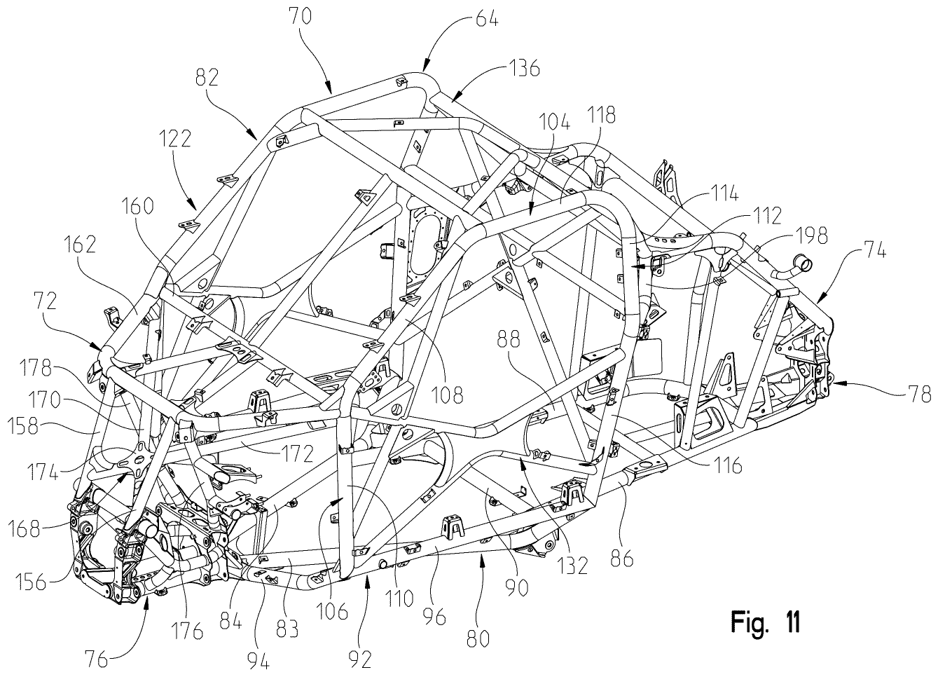

Referring now to FIGS. 11-16, lower frame portion 80 includes a first longitudinally extending frame member 83 extending generally rearwardly from front subassembly 76 and a second longitudinally extending frame member 84 extending generally rearwardly from front subassembly 76, and longitudinally extending members 83, 84 are laterally offset. A third longitudinally extending frame member 86 extends generally rearwardly from longitudinally extending frame member 83 and a fourth longitudinally extending frame member 88 extends generally rearwardly from longitudinally extending frame member 84, and longitudinal extending frame members 86, 88 are laterally offset. A first or driver-side frame assembly 92 extends generally upwardly from longitudinally extending frame member 83, and a second or passenger-side frame assembly 98 extends generally upwardly from longitudinally extending frame member 84. Driver-side frame assembly 92 includes a first frame member 94 extending upwardly from longitudinally extending frame member 83 and a second frame member 96 extending between first frame member 94 and longitudinally extending frame member 83. Similarly, passenger-side frame assembly 98 includes a first frame member 100 extending upwardly from longitudinally extending frame member 84 and a second frame member 102 extending between first frame member 100 and longitudinally extending frame member 84. In embodiments, skid plate 210 is supported by the bottom of each of longitudinally extending frame member 83, longitudinally extending frame member 84, frame member 86, and frame member 88.

Main frame portion 64 includes a first or driver door ring 104 and a second or passenger door ring 120. First door ring 104 includes an A-pillar 106 extending generally upwardly from driver-side frame assembly 92 and includes an upper A-pillar member 108 and a lower A-pillar member 110 coupled to the upper A-pillar member 108. First door ring 104 also includes B-pillar 112 extending generally upwardly from driver-side frame assembly 92, and B-pillar 112 is positioned generally rearwardly of A-pillar 106. B-pillar 112 includes an upper B-pillar member 114 and a lower B-pillar member 116 coupled to the upper B-pillar member 114. An upper frame member 118 extends between upper A-pillar member 108 and upper B-pillar member 114. That is, a fully enclosed ring (e.g., door ring 104) is formed by each of second frame member 96 of driver-side frame assembly 92, A-pillar 106, B-pillar 112 and frame member 104. Second door ring 120 includes an A-pillar 122 extending generally upwardly from passenger-side frame assembly 98 and includes an upper A-pillar member 124 and a lower A-pillar member 126 coupled to the A-pillar member 124. Second door ring 120 also includes B-pillar 128 extending generally upwardly from passenger-side frame assembly 98, and B-pillar 128 is positioned generally rearwardly of A-pillar 122. B-pillar 128 includes an upper B-pillar member 129 and a lower B-pillar member 131 coupled to the upper B-pillar member 129. An upper frame member 130 extends between upper A-pillar member 122 and upper B-pillar member 129. That is, a fully enclosed ring (e.g., door ring 120) is formed by each of second frame member 102 of passenger-side frame assembly 98, A-pillar 122, B-pillar 128, and frame member 130. In embodiments, a frame member 160 is coupled between A-pillar 106 and A-pillar 122.

Referring to FIGS. 11-14, a first door frame 132 is positioned within first door ring 104 and a second door frame 134 is positioned within second door ring 120.

Still referring to FIGS. 11-16, a roof frame 136 extends laterally across vehicle 2. In embodiments, roof frame 136 includes a first frame member 138 extending laterally between first door ring 104 and second door ring 120 and a second frame member 140 extending laterally between first door ring 104 and second door ring 120, and second frame member 140 is positioned longitudinally rearwardly of first frame member 138. A frame member 142 extends generally longitudinally between first frame member 138 and second frame member 140 and a frame member 144 extends generally longitudinally between first frame member 138 and second frame member 140. In embodiments, each of frame member 142, 144 are angled generally inwardly toward a longitudinal centerline L from a front-to-back direction. In embodiments, each of frame member 142, 144 have a generally convex shape facing inwardly toward an operator area 150 (e.g., frame members 142, 144 are generally arcuate and arcing away from operator area 150) to create more headroom for passengers.

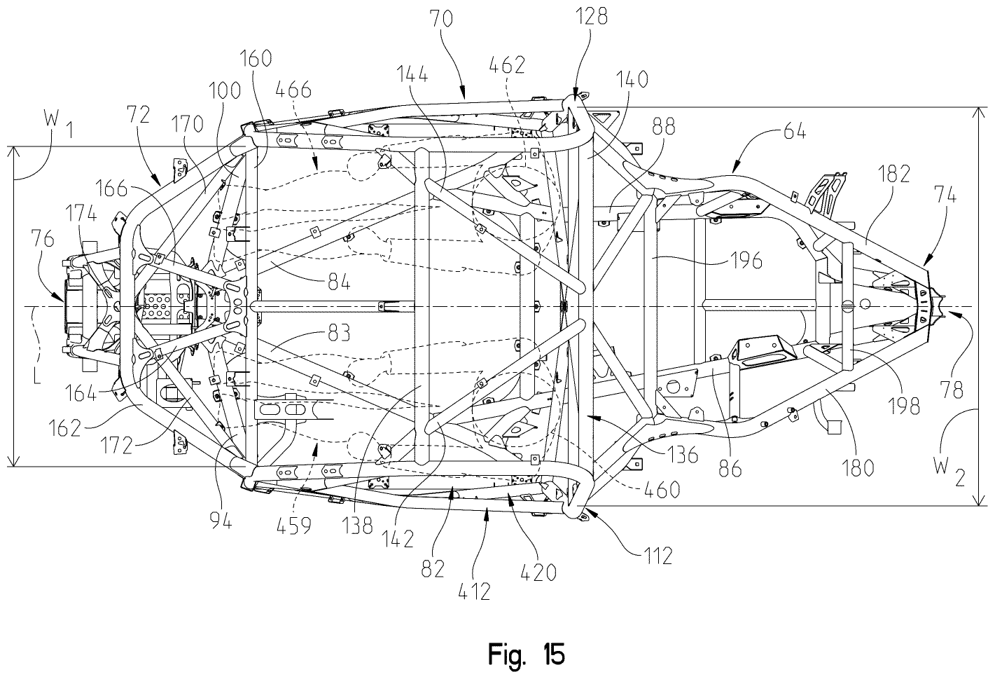

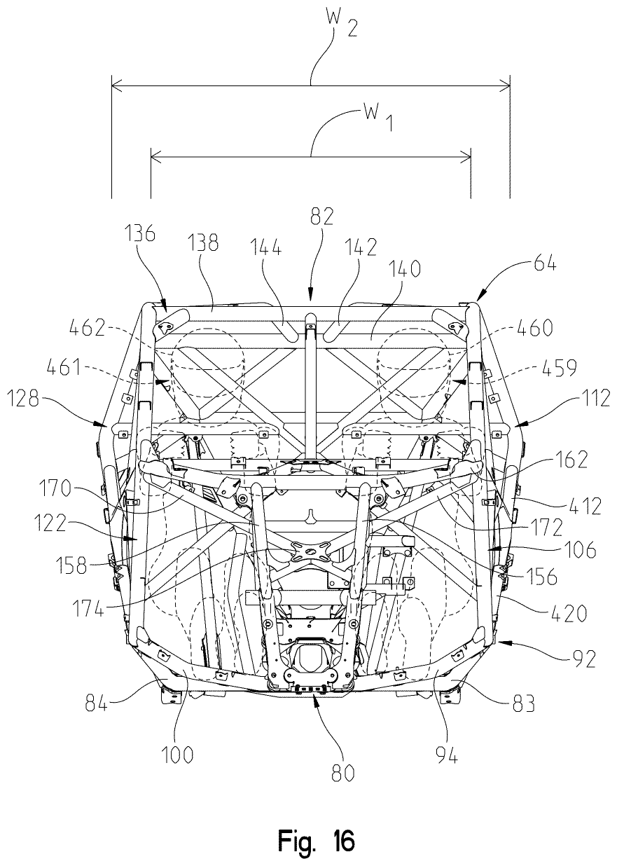

Referring to FIGS. 15-16, a driver 459 has an upper body portion 460 (e.g., a head or a head with a helmet) and a passenger 461 has an upper body portion 462 (e.g., a head or a head with a helmet). Frame members 142, 144 are angled (e.g., positioned) such that the crown, or upper extent, of the upper body portions 460, 462 may not contact frame members 142, 144. That is, frame member 142 is coupled to first frame member 138 at a position laterally inwardly from door ring 104 and extends rearwardly and inwardly such that upper body portion 460 of driver 459 may avoid frame member 142. Further, frame member 144 is coupled to first frame member 138 at a position laterally inwardly from door ring 120 and extends rearwardly and inwardly such that upper body portion 162 of passenger 461 may avoid frame member 144.

In embodiments, the operator area 150 is generally supported within the main frame portion 64 and is generally surrounded by the first door ring 104, second door ring 120, roof frame 136 and lower frame portion 80. In embodiments, operator area 150 supports a driver seat 152 and a passenger seat 154. In embodiments, operator area 150 only supports a driver seat 152. In embodiments, operator area 150 supports one seat, two seats, three seats, four seats, five seats, six seats, or more seats. In embodiments, a steering input 155 is positioned within operator area 160 and steering input 155 is operably coupled to one or more of ground engaging members 4, 6, 8, 10. In embodiments, steering input 155 is one of a steering wheel, handlebars, a joystick or another type of steering input.

Referring to FIGS. 9-16, front frame portion 72 includes a first vertically extending member 156 extending generally upwardly from front subassembly 76 and a second vertically extending member 158 extending generally upwardly from front subassembly 76, and each of vertically extending members 156, 158 are laterally offset. A U-shaped member 162 extends between and forward of A-pillar 106 and A-pillar 122, and couples with each of member 156 and member 158. In embodiments, U-shaped member 162 extends over front subassembly 76. In embodiments, a first longitudinally extending member 164 extends between u-shaped member 162 and frame member 160, and a second longitudinally extending member 166 extends between u-shaped member 162 and frame member 160.

Referring to FIGS. 11-16, front frame portion 72 includes an X-brace assembly 168 including a first cross-member 170, a second cross-member 172, and a brace 174. In embodiments, first cross-member 170 extends between member 156 and A-pillar 122 and second cross-member 172 extends between member 158 and A-pillar 106. In embodiments, the brace 174 is coupled to each of first cross-member 170 and second cross-member 172 to rigidify the front frame portion 72. In embodiments, a first member or downtube 176 extends downwardly from u-shaped member 162 to longitudinally extending frame member 83 and a second member or downtube 178 extends downwardly from u-shaped member 162 to longitudinally extending frame member 84.

Still referring to FIGS. 11-16, rear frame portion 74 includes a first upper longitudinally extending frame member 180 and a second upper longitudinally extending frame member 182 laterally offset from first upper longitudinally extending frame member 180. In embodiments, each of frame members 180, 182 extend generally between center frame portion 70 and rear subassembly 78. A first vertically extending member 184 extends between longitudinally extending member 86 and frame member 180, a second vertically extending member 186 extends between longitudinally extending member 88 and frame member 182 and member 186 is laterally offset from member 184. A third vertically extending member 188 extends between longitudinally extending member 86 and frame member 180 and member 188 is longitudinally offset from member 184. A fourth vertically extending member 190 extends between longitudinally extending member 88 and frame member 182 and member 190 is laterally offset from member 188 and longitudinally offset from member 186.

In embodiments, a cross-member 196 extends between frame member 180 and frame member 182, a cross-member 198 extends between b-pillar 112 and frame member 180, and a cross-member 200 extends between b-pillar 128 and frame member 182. A joint 206 is formed at the junction of each of frame member 180, cross-member 196, and cross-member 198 and a frame member 202 couples between second frame member 140 and joint 206. A joint 208 is formed at the junction of each of frame member 182, cross-member 196, and cross-member 200 and a frame member 204 couples between second frame member 140 and joint 208. In embodiments, frame 14 includes a plurality of mounting portions (e.g., mounting portion 192 and mounting portion 194). In embodiments, each of mounting portion 192 and mounting portion 194 are supported by rear frame portion 74. In embodiments, mounting portion 192 is supported by frame member 88 and mounting portion 194 is supported by frame member 86.

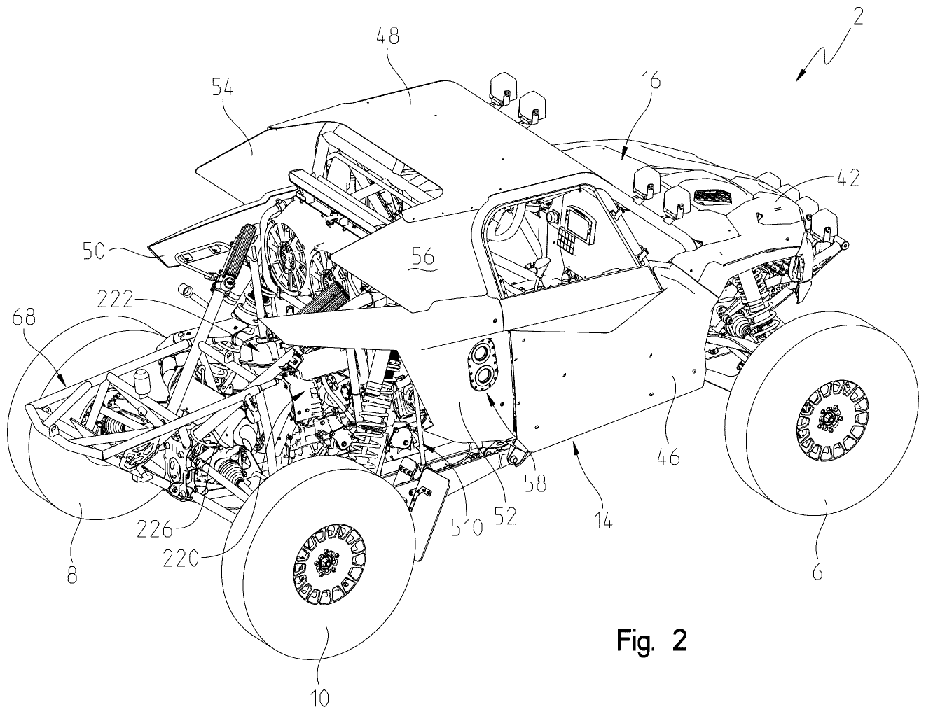

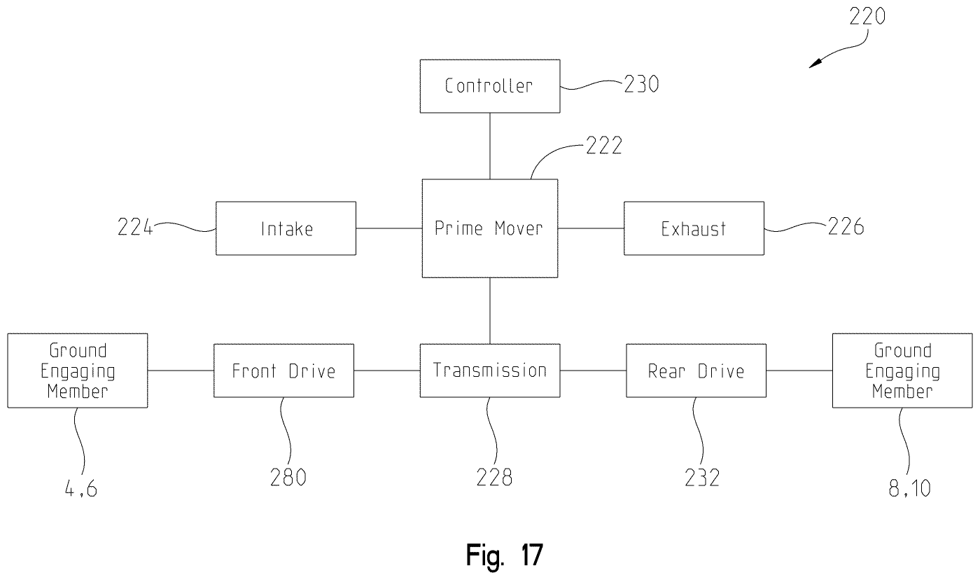

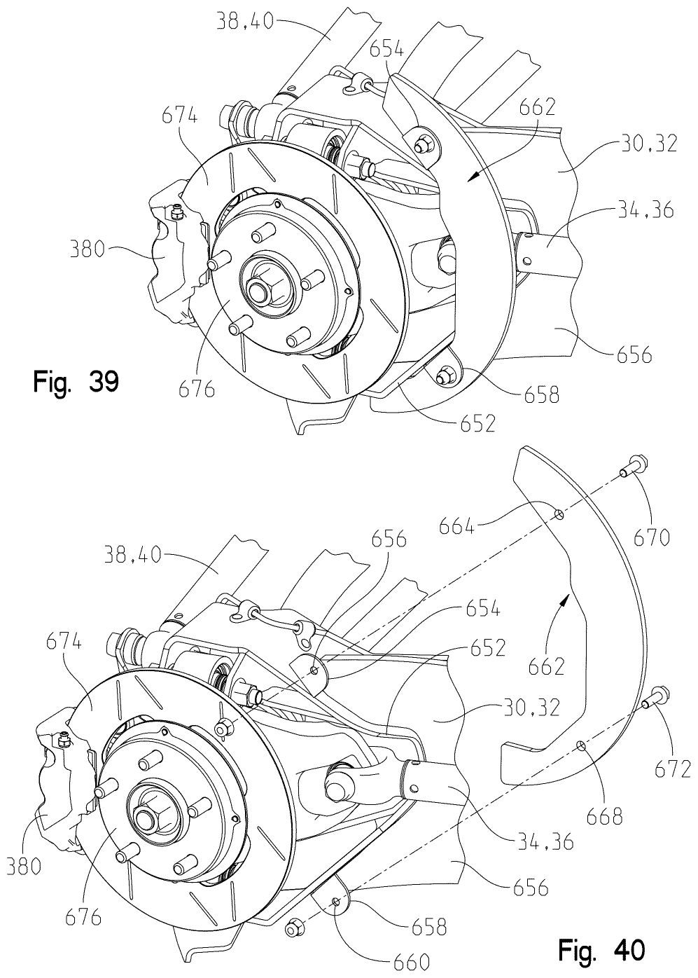

Referring now to FIG. 17, vehicle 2 includes a powertrain 220 supported by the frame and operably coupled to one or more of ground engaging members 4, 6, 8, 10. Powertrain 220 includes a prime mover 222 (also shown in FIGS. 2-5) including an air intake 224 (also shown in FIG. 1) and an air exhaust 226 (also shown in FIGS. 1-3, 5-6). In embodiments, powertrain 220 is an internal combustion engine 222. In embodiments, powertrain 220 includes an internal combustion engine 222 with a turbocharger or a supercharger. In embodiments, powertrain 220 is an electric motor including a battery (not shown). In embodiments, vehicle 2 includes a controller 230 operably coupled to the prime mover to control one or more operating characteristics of the prime mover 222. In embodiments, prime mover 222 is supported by each of mounting portions 192, 194 within rear frame portion 74. In embodiments, a cooling system 710 (FIG. 41) includes a heat exchanger 712 and a fan assembly 716. Heat exchanger 712 may cool fluid for the prime mover 222, for a turbocharger (e.g., as an intercooler), batteries, or another vehicle component. In embodiments, powertrain 220 includes a transmission 228 operably coupled between prime mover 222 and ground engaging members 4, 6, 8, 10. In embodiments, transmission 228 includes a continuously variable transmission (not shown) and a shiftable transmission (not shown). In embodiments, the shiftable transmission may shift between one or more reverse gears, one or more forward gears (e.g., High or Low), a neutral gear, and a park gear. In embodiments, transmission 228 is an automatic transmission, a manual transmission, an automated manual transmission, a dual clutch transmission, an automated sequential transmission, a hydraulic transmission, or another type of transmission. In embodiments, a front drive 280 is coupled intermediate the transmission 228 and ground engaging members 4, 6. In embodiments, a rear drive 232 is coupled intermediate the transmission 228 and ground engaging members, 8, 10. In embodiments, one or both of front drive 280 and rear drive 232 are differentials, and may be locking differentials, electronic differentials, active differentials, or other types of differentials. In embodiments, a pair of halfshafts 234 (FIG. 8) extend between rear drive 232 and ground engaging members 8, 10. In embodiments, a pair of halfshafts 236 (FIG. 7) extend between front drive 280 and ground engaging members 4, 6. Additional details regarding powertrain 220 may be found in U.S. Pat. No. 11,628,722, issued Apr. 18, 2023 and U.S. Patent Publication No. 2021/0323402, filed Apr. 16, 2021, the entire disclosures of which are incorporated herein by reference.

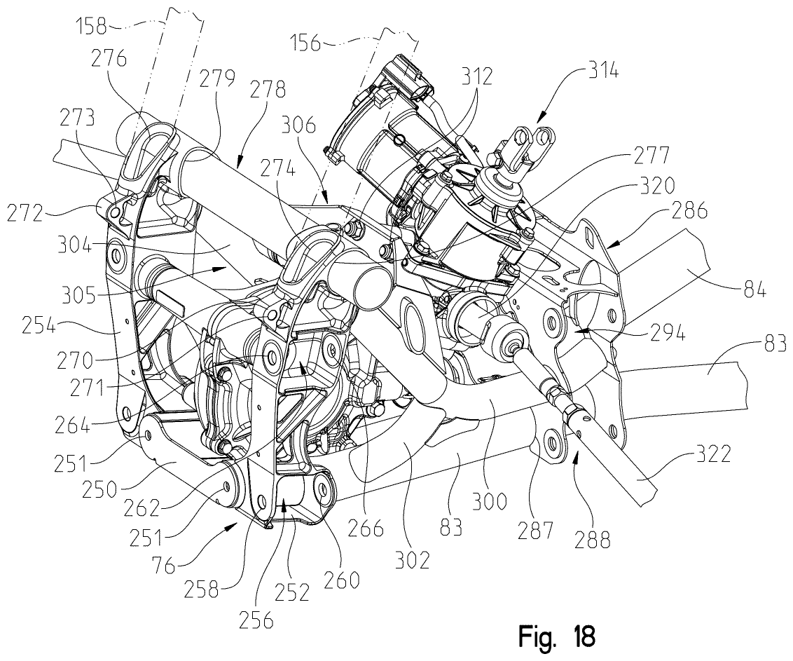

Referring now to FIGS. 18-19, front subassembly 76 includes a frame member 250 including a pair of apertures 251. Frame member 250 couples between a front extent of longitudinally extending frame member 83 and a front extent of longitudinally extending frame member 84. A first generally upstanding frame member or first frame member 252 is coupled to a front portion of longitudinally extending frame member 83 and first frame member 252 extends generally upwardly from longitudinally extending frame member 83 and a second frame member 254 is coupled to a front portion of longitudinally extending frame member 84 and second frame member 254 extends generally upwardly from longitudinally extending frame member 84. A second frame member 254 is coupled to a front portion of longitudinally extending frame member 84 and second frame member 254 extends generally upwardly from longitudinally extending frame member 84. In embodiments, each of first frame member 252 and second frame member 254 are cast members. First frame member 252 includes a first recess 256 and a first aperture 258 and second aperture 260 on opposite sides of first recess 256. First frame member 252 also includes a second recess 262 positioned above first recess 256 and a first aperture 264 and second aperture 266 on opposite sides of second recess 262. First frame member 252 also includes a first tab 270 defining an aperture 271. First frame member 252 includes an aperture 277 extending generally laterally at a position adjacent the upper portion of first frame member 252. In embodiments, a recessed portion 274 is positioned at an upper extent of first frame member 252, and member 156 is coupled to first frame member 252 at recessed portion 274. In embodiments, member 156 is welded to first frame member 252 at recessed portion 274. In embodiments, second frame member 254 is substantially similar to first frame member 252. In embodiments, second frame member 254 is symmetrical to first frame member 252. That is, second frame member 254 includes a first recess and opposing apertures (e.g., similar to first recess 254 and apertures 258, 260). Second frame member 254 also includes a second recess and opposing apertures (e.g., similar to second recess 262 and apertures 264, 266). Second frame member also includes a tab 272 defining an aperture 273. Second frame member 254 includes an aperture 279 extending generally laterally at a position adjacent the upper portion of second frame member 254. In embodiments, a recessed portion 276 is positioned at an upper extent of second frame member 254, and member 158 is coupled to second frame member 254 at recessed portion 276. In embodiments, second frame member 254 includes an aperture 268 (FIG. 18) facing generally laterally inwardly and first frame member 252 includes an aperture 268 (FIG. 18) facing generally laterally inwardly toward aperture 268 on second frame member 254.

Referring still to FIGS. 18-19, front subassembly 76 includes a bracket or frame member 286 coupled to each of longitudinally extending frame member 83 and longitudinally extending frame member 84, and frame member 286 is positioned rearwardly of each of first frame member 252 and second frame member 254. In embodiments, frame member 286 includes a first recess 288 with opposing apertures (similar to first recess 256 with apertures 258, 260) and frame member 286 includes a second recess 294 with opposing apertures (similar to second recess 262 with apertures 264, 266). Frame member 286 defines a plurality of apertures or arcuate portions 287 which may receive longitudinally extending frame member 83 and longitudinally extending frame member 84.

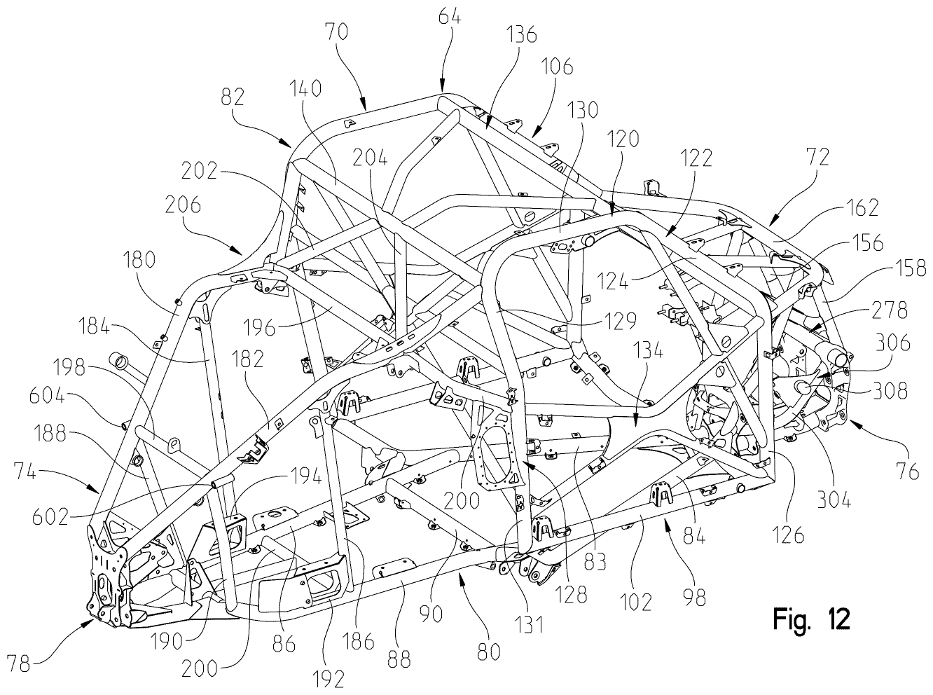

Still referring to FIGS. 18-19, a first frame member 300 extends between first frame member 252 and frame member 286, and a second frame member 302 extends between first frame member 300 and longitudinally extending frame member 83. Similarly, a first frame member 304 extends between second frame member 254 and frame member 286, and a second frame member (not shown, similar to frame member 302) extends between second frame member 302 and longitudinally extending frame member 84. A frame member or collar 306 extends between first frame member 300 and first frame member 304. In embodiments, collar 306 defines a pair of apertures 308, and the apertures 308 are laterally extending and axially aligned. In embodiments, apertures 308 are laterally extending, axially aligned, and laterally offset. That is, collar 306 includes a first aperture 308 positioned adjacent first frame member 300 and a second aperture 308 (FIG. 12) positioned adjacent first frame member 304. Collar 306 defines a pair of apertures 310. In embodiments, collar 306 is generally C-shaped and extends rearwardly from each of first frame member 300 and second frame member 302. In embodiments, a cavity 305 is defined forward of collar 306 and rearward of first frame member 252, second frame member 254. In embodiments, collar 306 is welded to first frame member 300 and first frame member 304 by one or more welds, adhesives, fasteners, or other coupling methods.

Referring still to FIGS. 18-19, front drive member 280 is positioned within front subassembly 76 and within cavity 305. Front drive member 280 includes a first mounting collar 282 and a second mounting collar 284 positioned rearwardly from the first mounting collar 282. In embodiments, each of the first mounting collar 282 and second mounting collar 284 are positioned toward an upper extent of front drive 280. In embodiments, first mounting collar 282 is coupled between aperture 268 of first frame member 252 and aperture 268 of second frame member 254 and second mounting collar 284 is coupled between first aperture 308 and second aperture 308 of collar 306.

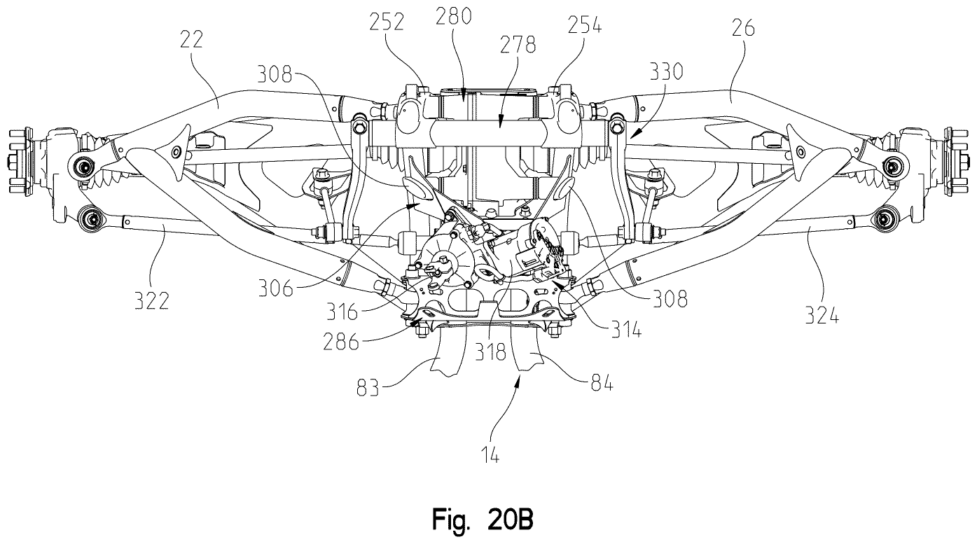

Referring still to FIGS. 18-20B, vehicle 2 includes a steering unit 314 operably coupled to steering input 155. Steering unit 314 includes an input 316, a motor 318, a steering rack 320, and a pair of steering arms 322, 324. Further, a steering column 326 (FIG. 21A) is coupled between steering input 155 and input 316. In embodiments, steering arms 322, 324 are coupled between steering rack 320 and ground engaging members 4, 6. In embodiments, steering arms 322, 324 are coupled between steering rack 320 and at least one of ground engaging members 4, 6, 8, 10. In embodiments, steering unit 314 is coupled to collar 306. In embodiments, steering rack 320 includes a plurality of apertures 311, and apertures 311 align with apertures 310 on collar 306. A plurality of fasteners 312 extend through apertures 310 and apertures 311 to couple steering unit 314 to collar 306. In embodiments, steering unit 314 may be removed from front subassembly 76 by removing fasteners 312 and lifting steering unit 314 out from behind collar 306. In embodiments, when steering unit 314 is installed into front subassembly 76 (e.g., FIG. 18), steering arms 322, 324 extend laterally outwardly and extend over first frame member 300, first frame member 304, respectively, and forward of frame member 286. In embodiments, steering unit 314 and steering rack 320 are positioned rearwardly of drive member 278 and steering unit 314 and steering rack 320 are positioned forwardly of bracket 286.

Referring to FIGS. 18-20B, a sleeve 278 extends between apertures 277, 279. In embodiments, sleeve 278 extends laterally beyond each of apertures 277, 279. In embodiments, sleeve 278 is coupled to apertures 277, 279 by a weld, a fastener, an adhesive, or another coupling method. In embodiments, sleeve 278 is welded to each of the apertures 277 of first frame member 252 and aperture 279 of second frame member 254. A stabilizer bar assembly 330 includes a stabilizer bar or member 332 extending through sleeve 278, a pair of arms 334 coupled to either end of member 332, and a pair of links 336 coupled between arms 334 and lower suspension arms 24, 28, respectively. Stabilizer bar assembly 330 constrains movement of lower arm 18 relative to lower arm 28, and the movement of lower arm 28 relative to lower arm 18. In embodiments, arms 334 extend rearwardly from member 332 such that member 332 is positioned forwardly of links 336.

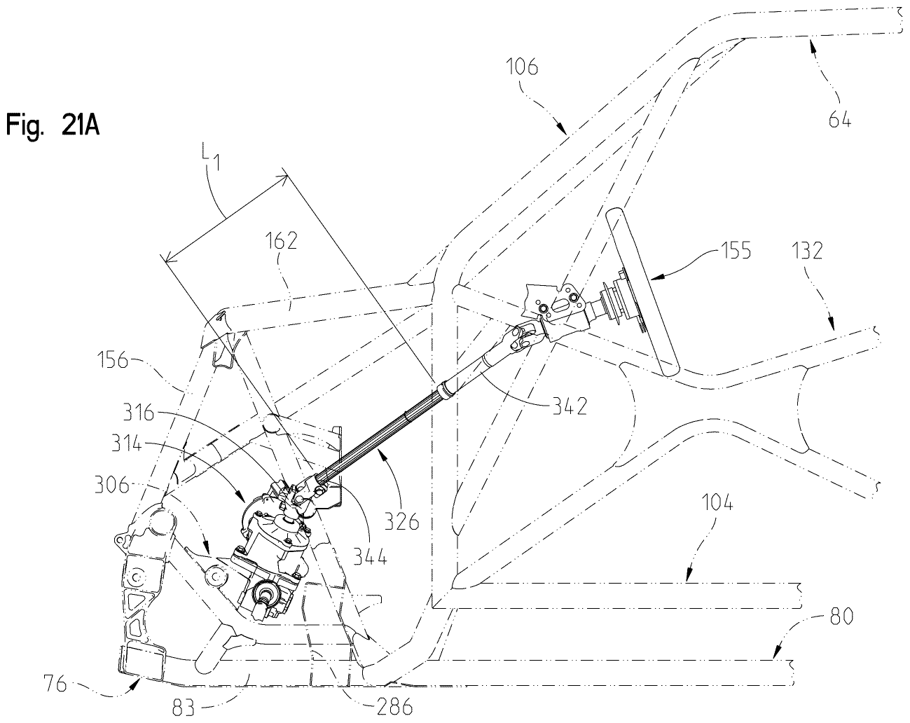

Referring now to FIGS. 21A-22, steering column 326 includes a splined portion 338 coupled to input 316 and a stop member 340 coupled to the splined portion 338. Steering column 326 also includes a collar portion 342 coupled to steering input 155 which may translate along the splined portion 338. In embodiments, collar portion 342 is generally statically positioned along splined portion 338 by a friction fit (e.g., under the friction forces between splined portion 338 and collar portion 342). In embodiments, collar portion 342 translates along splined portion 338 when steering column 326 is collapsed under a predetermined force. In embodiments, steering column 326 may collapse a predetermined distance (e.g., collar portion 342 may translate along splined portion 338 a predetermined distance). Referring to FIG. 21A, steering column 326 is in an uncompressed position, and the collar portion 342 is positioned a length L1 from a bottom extent 344 of splined portion 338. Referring to FIG. 21B, steering column 326 is in a compressed position, and the collar portion 342 is positioned a length L2 from a bottom extent 344 of splined portion 338, and the length L2 is less than the length L1. That is, steering column 326 may be compressed to absorb a force to steering unit 314 which may reduce the movement of steering input 155 in response to the force provided to the steering unit 314.

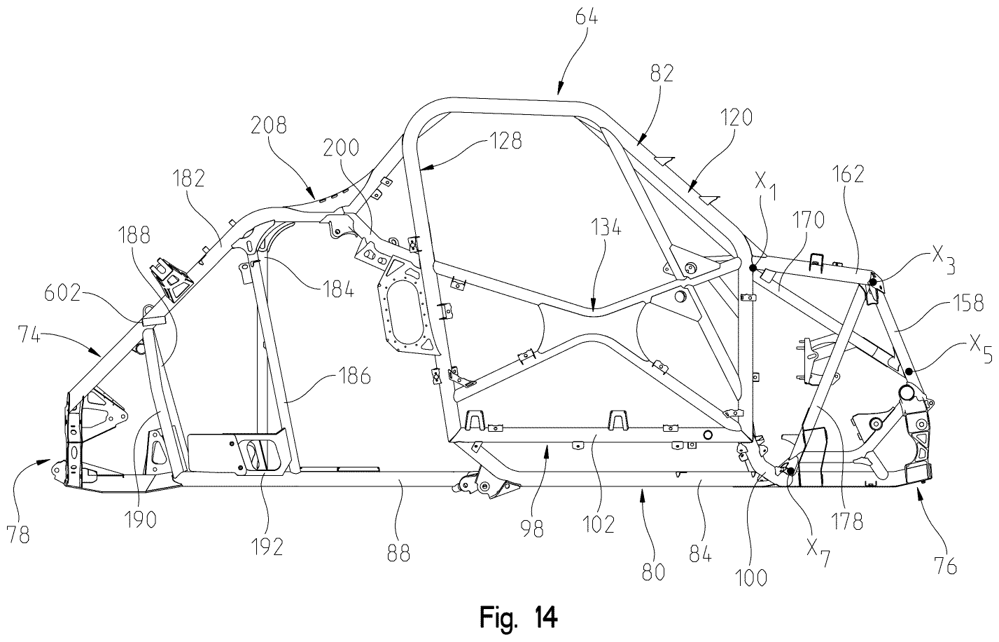

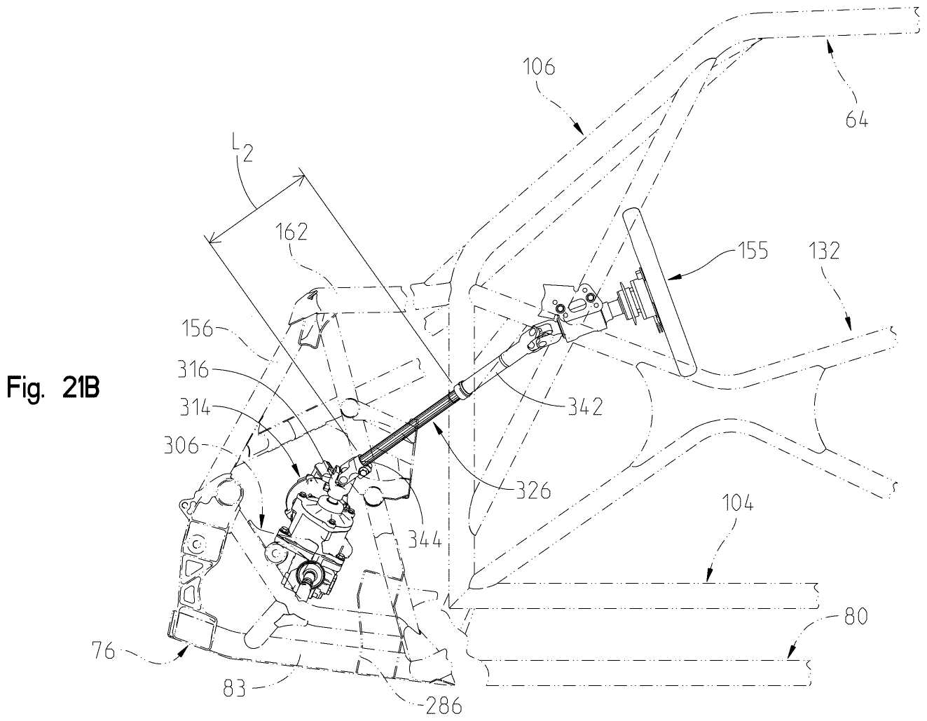

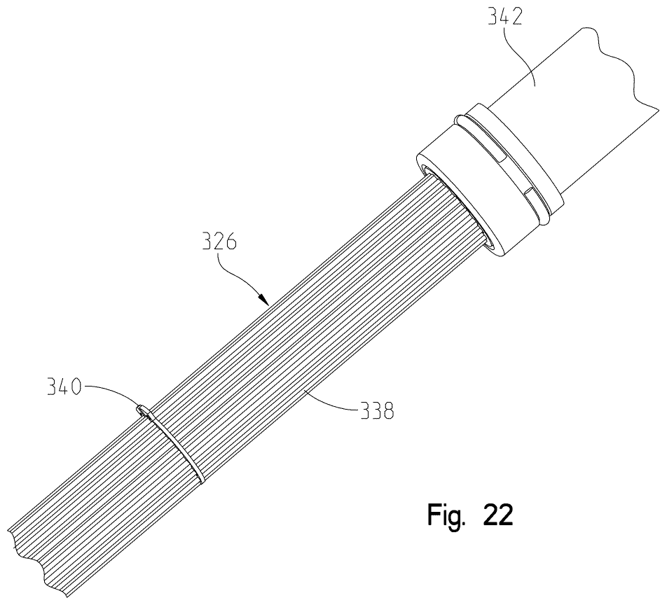

Referring now to FIGS. 23-24, first cross-member 170 of x-brace assembly 168 includes a first shaft portion 170A and a second shaft portion 170B and first shaft portion 170A is coupled to a first side 172A of second cross-member 172 and second shaft portion 170B is coupled to a second side 172B of second cross-member 172 opposite the first side 172A. In embodiments, first cross-member 170 is coupled to member 158 and second cross-member 172 is coupled to member 156. In embodiments, member 156 defines a notch or aperture 346 and member 158 defines a notch or aperture 348. In embodiments, notch 346 is a scalloped portion and notch 348 is a scalloped portion. In embodiments, first cross-member 170 sits within notch 348, and first cross-member 170 is coupled to member 158 by a weld along notch 348. In embodiments, first cross-member 170 is coupled to member 158 by one or more of a weld, adhesive, fastener, or another coupling method. In embodiments, second cross-member 172 sits within notch 346, and second cross-member 172 is coupled to member 156 by a weld along notch 346. In embodiments, second cross-member 172 is coupled to member 156 by one or more of a weld, adhesive, fastener, or another coupling method. By coupling x-brace assembly 168 to member 156 and member 158, front frame portion 72 is strengthened and rigidified. In embodiments, first cross-member 170 is coupled to u-shaped member 162 at a first mounting portion X1 (FIG. 9) and extends downwardly to couple to member 156 at a sixth mounting portion X6 (FIG. 9). In embodiments, second cross-member 172 is coupled to u-shaped member 162 at a second mounting portion X2 (FIG. 9) and extends downwardly to couple to member 158 at a fifth mounting portion X5 (FIG. 9). In embodiments, downtube 178 is coupled to u-shaped member 162 at a third mounting portion X3 (FIG. 9) and downtube 176 is coupled to u-shaped member 162 at a fourth mounting portion X4 (FIG. 9). In embodiments, downtube 178 extends between third mounting portion X3 on u-shaped member 162 and a seventh mounting portion X7 (FIG. 14) along longitudinally extending frame member 84 of lower frame portion 80. In embodiments, downtube 176 extends between fourth mounting portion X4 on u-shaped member 162 and an eighth mounting portion X8 (FIG. 9) along longitudinally extending frame member 83 of lower frame portion 80.

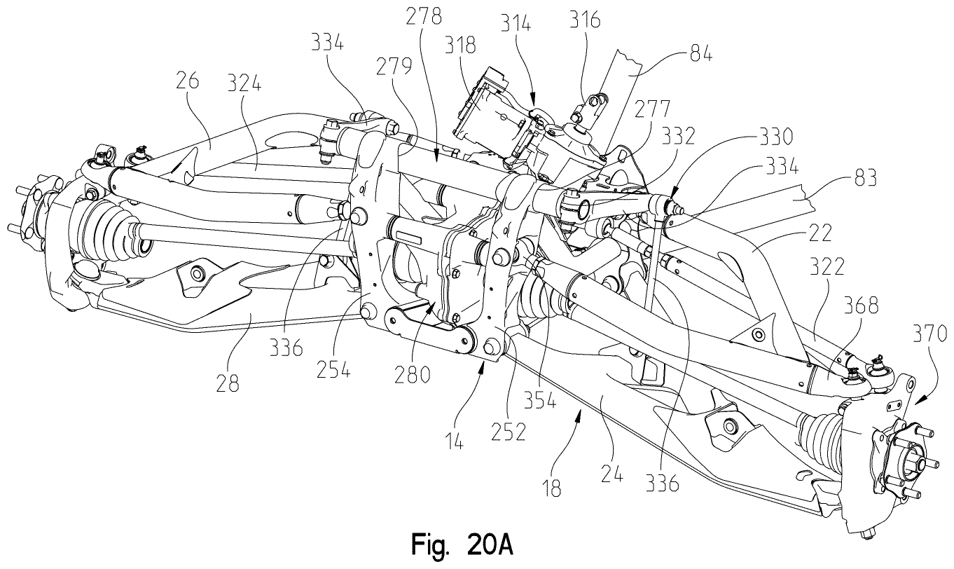

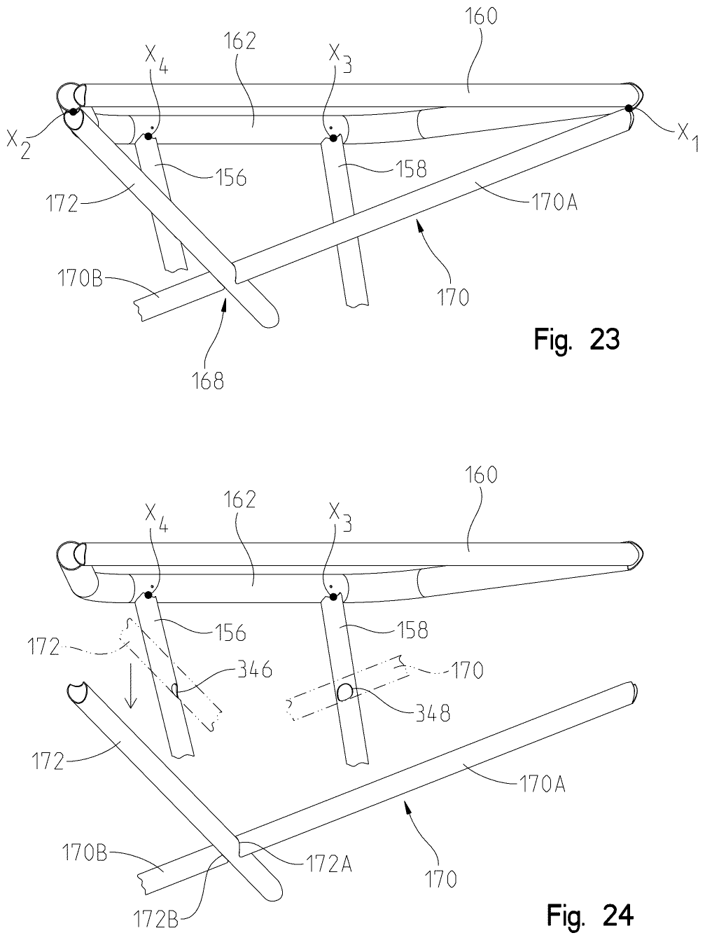

Referring now to FIGS. 25A-25B, upper A-arms 22, 26 include a first arm 350, a second arm 352, and each of the first arm 350 and second arm 352 couple together at an outer end joint 368. In embodiments, outer end joint 368 is a ball joint joined to a knuckle 370 (FIG. 20A) and knuckle may be coupled to a ground engaging member (e.g., ground engaging member 4). First arm 350 includes an inner end joint 354 and second arm 352 includes an inner end joint 356. In embodiments, each of inner end joint 354 and inner end joint 356 are ball joints. In embodiments, each of inner end joints 354, 356 rotate on a rotatable joint, or rotate on a bushing. In embodiments, A-arm 22 is coupled to frame 14 at each of inner end joints 354, 356. That is, inner end joint 354 sits within recess 262 and inner end joint 356 sits within recess 294, and a fastener (not shown) extends through apertures 264, 266, and end joint 354 and a fastener (not shown) extends through apertures 296, 298, and end joint 356 to couple A-arm 22 to frame 14. In embodiments, each A-arm 22, 24, 26, 28 include inner end joints (not shown, e.g., end joints 354, 356) and couple to front subassembly 76 of frame 14 at the various recesses (e.g., also at recesses 256, 288 and corresponding recesses on right side of front subassembly 76).

Referring still to FIGS. 25A-25B, first arm 350 includes a collar 358 positioned on an inner end adjacent inner end joint 354 and second arm 352 includes a collar 362 positioned on an inner end adjacent inner end joint 356. In embodiments, each of inner end joint 354, 356 includes a stud 366 which may be threaded or otherwise provided with an engagement surface (e.g., threads, splines, etc.). In embodiments, each of collar 358, collar 362 define internal threads or another internal engagement surface, and the internal threads may engage the stud 366. That is, inner end joint 354, inner end joint 356 may rotate within collar 358, collar 362, respectively, to adjust a depth of inner end joint 354, inner end joint 356 within collar 358, collar 362, respectively. In embodiments, a nut 360 is coupled with stud 366 of inner end joint 354 (e.g., threadedly coupled) and the position of nut 360 on stud 366 of inner end joint 354 determines how far inner end joint 354 may be threaded into collar 358 of first arm 350. In embodiments, a nut 364 is coupled with stud 366 of inner end joint 356 (e.g., threadedly coupled) and the position of nut 364 on stud 366 of inner end joint 356 determines how far inner end joint 356 may be threaded into collar 362 of second arm 352.

Still referring to FIGS. 25A-25B, in embodiments, only first arm 350 includes an adjustable end joint (e.g., inner end joint 354). In embodiments, only second arm 352 includes an adjustable end joint (e.g., inner end joint 356). In embodiments, each of first arm 350 and second arm 352 includes an adjustable end (e.g., inner end joint 354 and inner end joint 356). In embodiments, adjustability of the inner adjustable end joints (e.g., inner end joint 354 and inner end joint 356) allows for an operator of vehicle 2 to adjust the adjustable end joints (e.g., inner end joint 354 and/or inner end joint 356) to change the kinematics of the front suspension 18. That is, an operator may withdraw or insert one or more of the adjustable end joints 354, 356 to increase or decrease, respectively, the length of arms 350, 352 between the frame 14 and the knuckle 370 (FIG. 20A) to alter the camber of the ground engaging member (e.g., ground engaging member 4). In embodiments, an operator may withdraw or insert one or more of the adjustable end joints 354, 356 to increase, or decrease, respectively the length of one or more of arms 350, 352, between the frame 14 and the knuckle 370 to alter the toeing characteristics of the ground engaging member (e.g., ground engaging member 4). Each of first arm 350 and second arm 352 are coupled to knuckle 370 at outer end joint 368, and an adjustment to either of inner end joint 354 or inner end joint 356 will adjust the kinematics of the ground engaging member by adjusting the position in space of the outer joint 368 coupling with the knuckle 370.

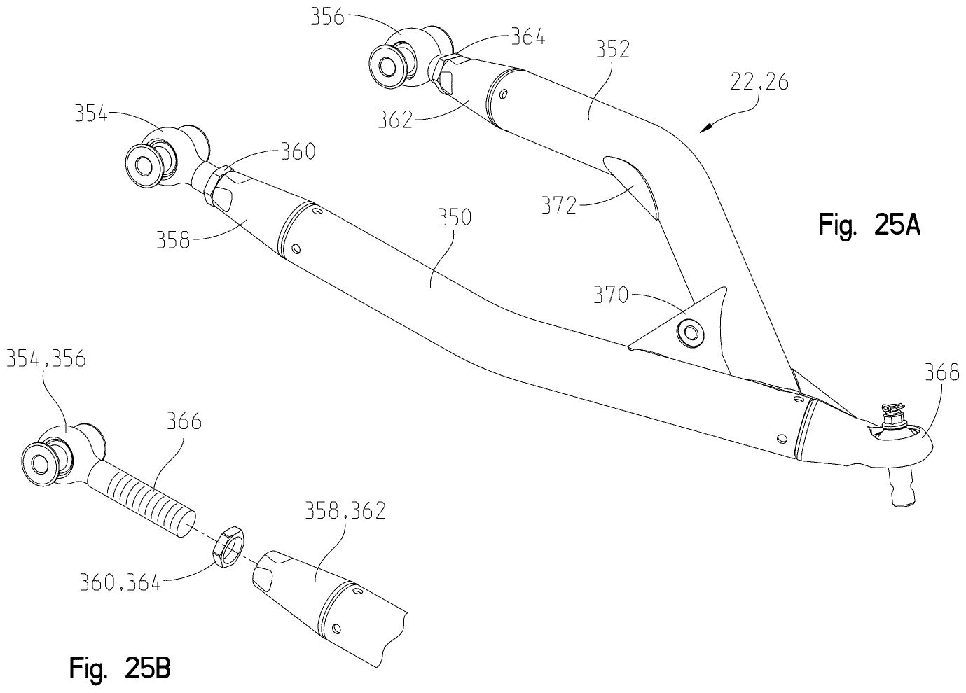

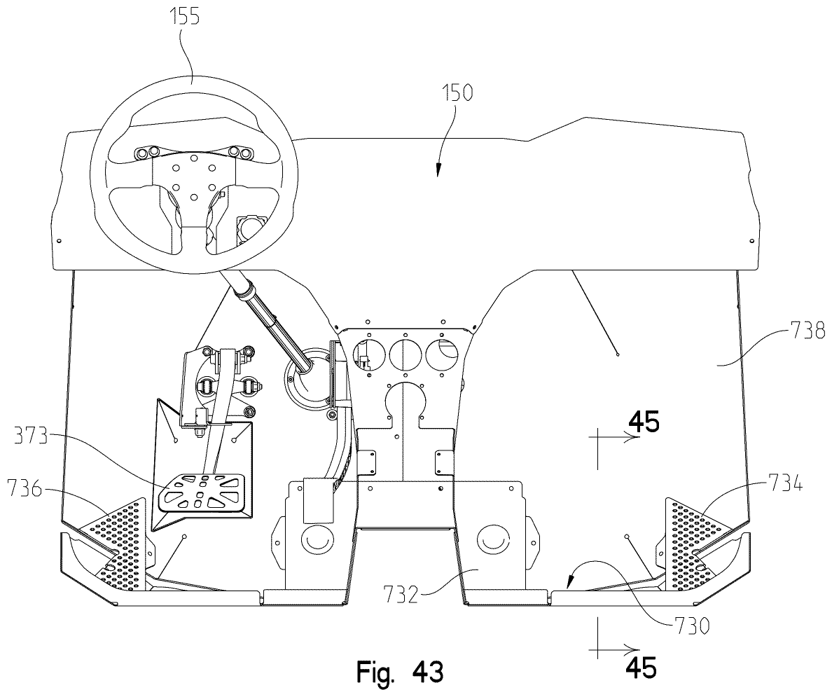

Referring now to FIG. 26, vehicle 2 includes a braking assembly 372 supported by the frame 14. Braking assembly 372 includes a brake input 373 (e.g., a brake pedal, FIG. 43) positioned within operator area 150 and accessible to an operator of vehicle 2. In embodiments, brake input 373 is operably coupled to a master cylinder 374. In embodiments, braking assembly 372 may include two master cylinders 374 operably coupled to brake input 373. In embodiments, master cylinder 374 is operably to alter the pressure within a plurality of conduits 386 to control one or more brake calipers. In embodiments, vehicle 2 includes a first brake caliper 376 coupled to ground engaging member 4, a second brake caliper 378 coupled to ground engaging member 6, a third brake caliper 380 coupled to ground engaging member 8, and a fourth brake caliper 382 coupled to ground engaging member 10. That is, each brake caliper 376, 378, 380, 382 may control a brake pressure provided to ground engaging member 4, 6, 8, 10, respectively by providing pressure to, for example, a brake disc, or to the wheel of the ground engaging member. Conduits 386 may be filled with a fluid (e.g., brake fluid) which may be incompressible. Conduits 386 may also be filled with another fluid such as water, oil, or another suitable fluid. In embodiments, brake assembly 372 includes a brake controller 384 which may automatically control brake pressure to one or more of brake calipers 376, 378, 380, 382.

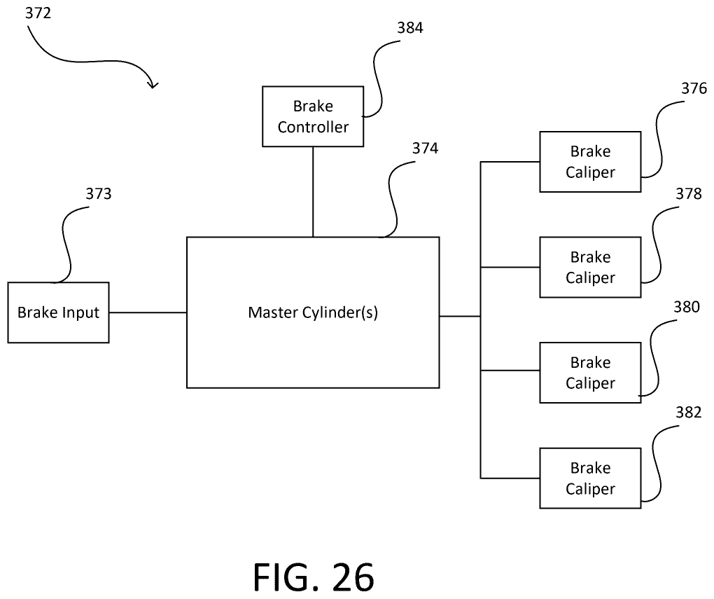

Referring now to FIGS. 27A-27B, a frame member 388 extends laterally from downtube 176, and a support assembly 390 is coupled to frame member 388. Front wall 45 defines a pair of apertures 386, and support assembly 390 couples between frame member 388 and front wall 45 adjacent apertures 386. In embodiments, support assembly 390 defines a pair of vertically extending walls 391, and vertically extending walls each define an aperture 392, 394.

Still referring to FIGS. 27A-27B, master cylinders 374 are supported by a body or support member 400, and support member 400 defines an aperture 402 and an aperture 404 at the bottom of support member 400. In embodiments, support member 400 sits between walls 391 and aperture 402 is aligned with apertures 392 and aperture 404 is aligned with apertures 404. A fastener 396 extends through apertures 392 and aperture 402 and a fastener 398 extends through apertures 394 and aperture 404 to couple support member 400 to support assembly 390 and couple master cylinders 374 to frame 14. That is, master cylinders 374 are supported by the frame 14 only at a bottom extent (e.g., a bottom of support member 400) and decreases the packaging size of the brake assembly 272, and more room is created for other components in front of front wall 45 (e.g., a frame member 406 extends laterally from downtube 176

and a bracket 408 defines an aperture 410 and extends between frame member 406 and front wall 45, and bracket 408 is positioned above support member 400 and master cylinders 374).

Referring still to FIGS. 27A-27B, master cylinders 374 include plungers 375 coupled between master cylinders 374 and brake input 373. In embodiments, master cylinders 374 are positioned so that plungers 375 may extend through apertures 386. In embodiments, a collar 387 is sealingly (or partially sealingly) coupled between master cylinder 374 and front wall 45 to prevent or decrease dust and debris intrusion from a forward portion of vehicle 2. In embodiments, each master cylinder 374 includes a collar 387.

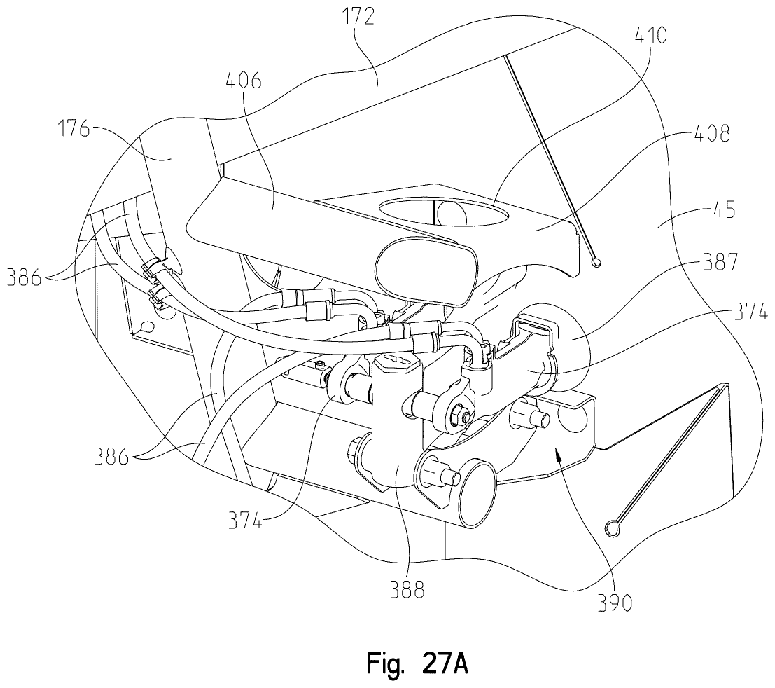

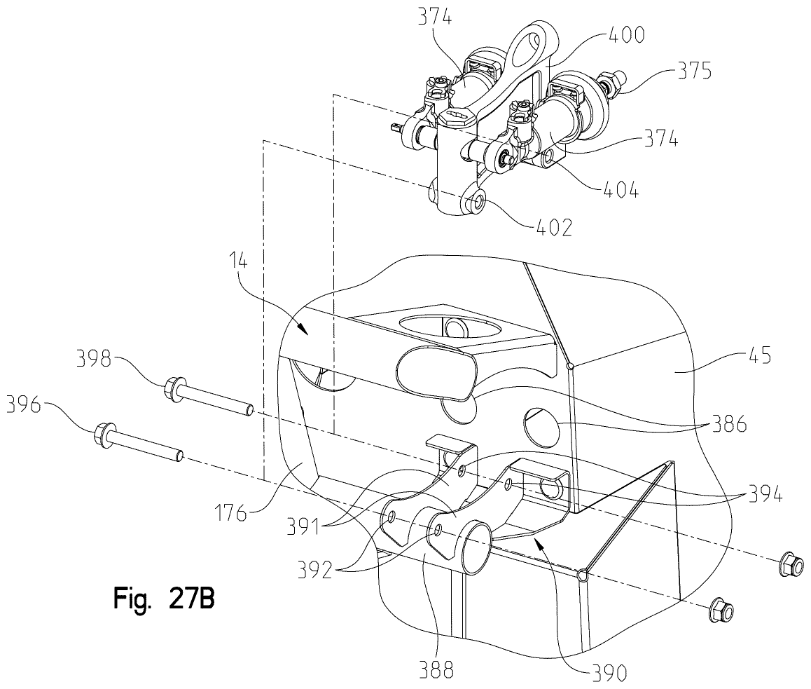

Referring now to FIGS. 28-29, door ring 104 accommodates door frame 132 and first door frame 132 includes a first frame member 412, a second frame member 420, and a gusset assembly 431. In embodiments, second door frame 134 is substantially similar to, or the same as, first door frame 132, and second door ring 120 accommodates door frame 134 in substantially the same manner that door ring 104 accommodates door frame 132. In embodiments, door frame 134 is a mirrored version of, or symmetrical about longitudinal axis L from, door frame 132. First frame member 412 includes a first portion 414, a second portion 416, and a third portion 418. In embodiments, first portion 414 may be coupled to and extend forwardly from lower b-pillar member 116 of b-pillar 112 and third portion 418 may be coupled to and extend rearwardly from lower a-pillar member 110 of a-pillar 106 and second portion 416 may be coupled between first portion 414 and third portion 418. In embodiments, first frame member 412 is a single frame member bent to accommodate the first portion 414, second portion 416, and third portion 418. Referring to FIG. 15, frame member 412 bends outwardly from a front-to-back direction such that the B-pillar 112 is positioned further laterally outwardly relative to the longitudinal centerline than the A-pillar 106. That is, A-pillar 106 is laterally separated from A-pillar 122 by a first width W1 and B-pillar 112 is laterally separated from B-pillar 128 by a second width W2, and second W2 is greater than first width W1. Frame member 412 bends outwardly from a front-to-back direction to create more passenger room towards the rear of operator area 150 to increase the space for a driver and a passenger (e.g., increasing the second width W2 at the B-pillars 112, 128 increases shoulder space for both the driver and passenger.)

Referring again to FIGS. 28-29, second frame member 420 includes a first portion 422, a second portion 424, and a third portion 426. In embodiments, first portion 422 may be coupled to and extend forwardly from lower b-pillar member 116 of b-pillar 112 and third portion 426 may be coupled to and extend rearwardly from lower a-pillar member 110 of a-pillar 106 and second portion 424 may be coupled between first portion 422 and third portion 426.

Gusset assembly 431 includes a first panel 432 and a second panel 438. First panel 432 includes a first edge 434 and a second edge 436 and second panel 438 includes a first edge 440 and a second edge 442. In embodiments, first panel 432 couples to each of first frame member 412 and second frame member 420 on an inner side adjacent operator area 150 and second panel 438 couples to each of first frame member 412 and second frame member 420 on an outer side opposite operator area 150. In embodiments, first edge 434 is coupled to first edge 440 and second edge 436 is coupled to second edge 442. In embodiments, gusset assembly 431 is assembled and coupled to first frame member 412 and second frame member 420 by one or more of adhesives, fasteners (e.g., bolts or rivets), and welds. Gusset assembly 431 increases the strength of first door frame 132 by increasing the torsional strength of first door frame 132.

Still referring to FIGS. 28-29, a frame member 428 may couple between upper a-pillar member 108 of a-pillar 106 and third portion 418 and a frame member 430 may couple between third portion 418 and lower a-pillar member 110 of a-pillar 106. A pair of gussets 444 may be coupled between each of frame member 428, third portion 418 and between each of frame member 430, third portion 418, respectively.

Referring again to FIGS. 28-29, a first light 446 and a second light 448 are coupled to A-pillar 106. A first bracket 450 is coupled to upper a-pillar member 108 of a-pillar 106 and a second bracket 452 is coupled to upper a-pillar member 108 of a-pillar 106 vertically higher than first bracket 450. In embodiments, first bracket 450 defines an aperture 451 and second bracket 452 defines an aperture 453. In embodiments, a fastener (not shown) extends through aperture 451 of first bracket 450 and first light 446 to couple first light 446 to a-pillar 106. In embodiments, a fastener (not shown) extends through aperture 453 of second bracket 452 and second light 448 to couple second light 448 to a-pillar 106. In embodiments, first light 446 includes an adjustment assembly 454 and second light 448 includes an adjustment assembly 456. In embodiments, adjustment assemblies 454, 456 allow lights 446, 448 to be rotated upwardly and downwardly about a first axis A1 (e.g., a horizontal axis) to adjust the angle of a light beam (not shown) created by lights 446, 448. In embodiments, lights 446, 448 may be rotated about a second axis A2 (e.g., a vertical axis normal to first axis A1) to adjust the angle of a light beam created by lights 446, 448.

In embodiments, a third light 447 (FIG. 1) and a fourth light 449 (FIG. 1) are coupled to A-pillar 122 (FIG. 1) in a substantially similar, or the same manner first light 446 and second light 447 are coupled to A-pillar 106.

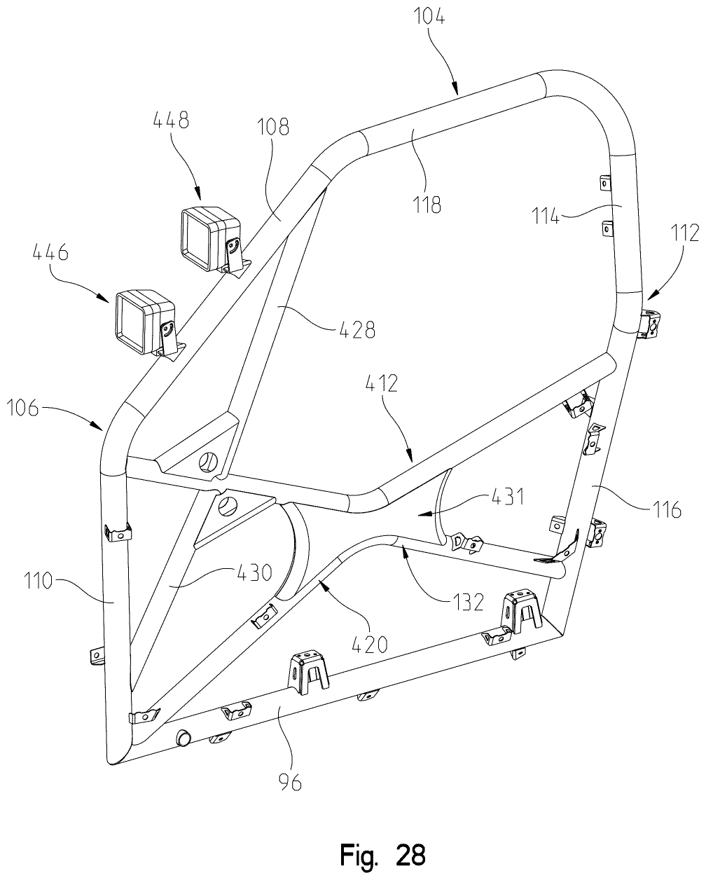

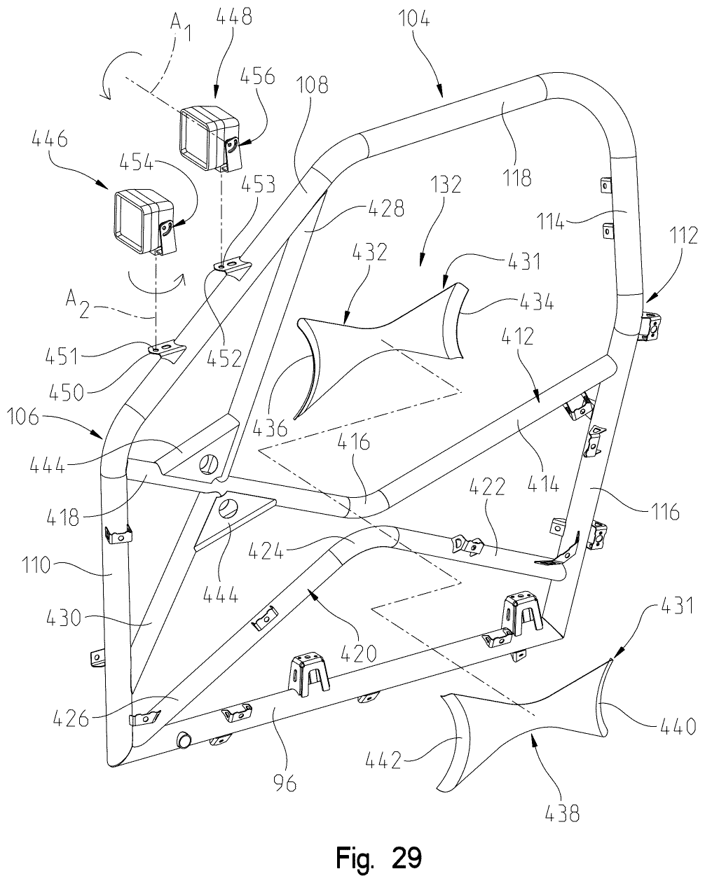

Referring now to FIGS. 30-31, a frame member 464 includes a mounting portion 466, a first leg portion 468, and a second leg portion 470. A first bracket 472 is coupled to first leg portion 468 and first bracket 472 defines an aperture 476. A second bracket 474 is coupled to second leg portion 470 and second bracket 474 defines an aperture 478. A third bracket 480 is coupled to mounting portion 466 and a fourth bracket 484 is coupled to mounting portion 466 offset from third bracket 480. Third bracket 480 defines an aperture 482 and fourth bracket 484 defines an aperture 486.

Still referring to FIGS. 30-31, a bracket 488 is coupled to member 184 of rear frame portion 74 and bracket 488 defines an aperture 490. A bracket 492 is coupled to frame member 180 of rear frame portion 74 and bracket 492 defines an aperture 494. In embodiments, a fastener 496 extends through aperture 476 of bracket 472 and aperture 490 of bracket 488 to couple first leg portion 468 to bracket 488 of member 184. In embodiments, a fastener 498 extends through aperture 478 of bracket 474 and aperture 494 of bracket 492 to couple second leg portion 470 to bracket 492 of frame member 180.

Still referring to FIGS. 30-31, driver rear fender panel 50 of body assembly 16 couples to frame member 464. In embodiments, driver rear fender panel 50 includes a pair of apertures (not shown) and a fastener (not shown, e.g., a screw, a bolt, or another fastener) extends through aperture 482 and a fastener (not shown, e.g., a screw, a bolt, or another fastener) extends through aperture 486 to couple frame member 464 to driver rear fender panel 50.

In embodiments, frame member 464 is formed of a tubular material (e.g., small-gauge steel) and brackets 472, 474, 480, 484 are coupled to the tubular material by a weld, adhesive, fastener, or other method.

During operation, vehicle 2 may move quickly around sharp corners and may contact trees, rocks, or other obstacles which may contact, scratch, dent, or otherwise destroy a body panel (e.g., body panel 50) of the body assembly 16. In embodiments, a body panel (e.g., body panel 50) may become snagged on a branch or other obstacle and want to pull off of vehicle 2. Frame member 464 acts as a ‘fuse’ piece between the body panel (e.g., body panel 50) and frame 14 such that when a body panel is snagged on an obstacle (e.g., a tree branch) the body panel will pull off instead of transferring forces through other adjacent members, such as adjacent frame members or adjacent body panels. In embodiments, under a predetermined force, one or more of the brackets 472, 474, 480, 484 may separate from any of mounting portion 466, first leg portion 468, or second leg portion 470 to allow driver rear fender panel 50 to separate from frame member 464 or to allow frame member 464 to separate from frame 14. In embodiments, fasteners 496, 498 (or fasteners coupled between frame member 464 and driver rear fender panel 50) may have a predetermined shear force to break to allow driver rear fender panel 50 to separate from frame member 464 or to allow frame member 464 to separate from frame 14.

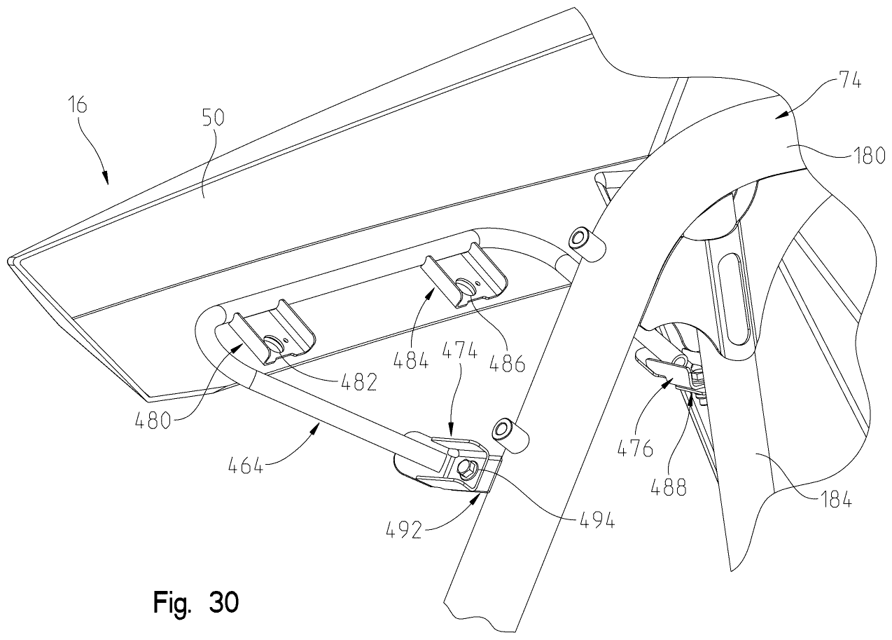

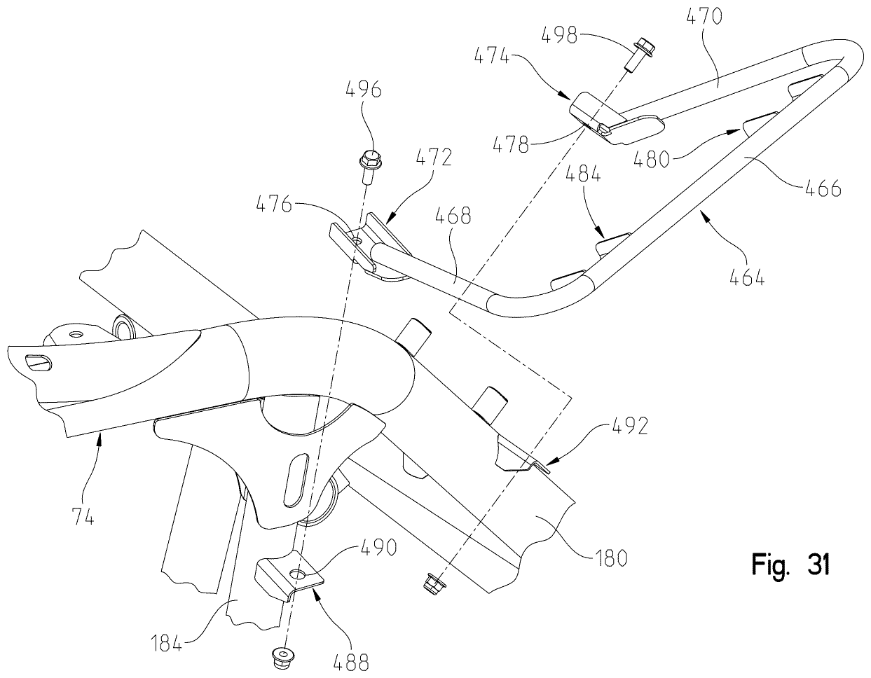

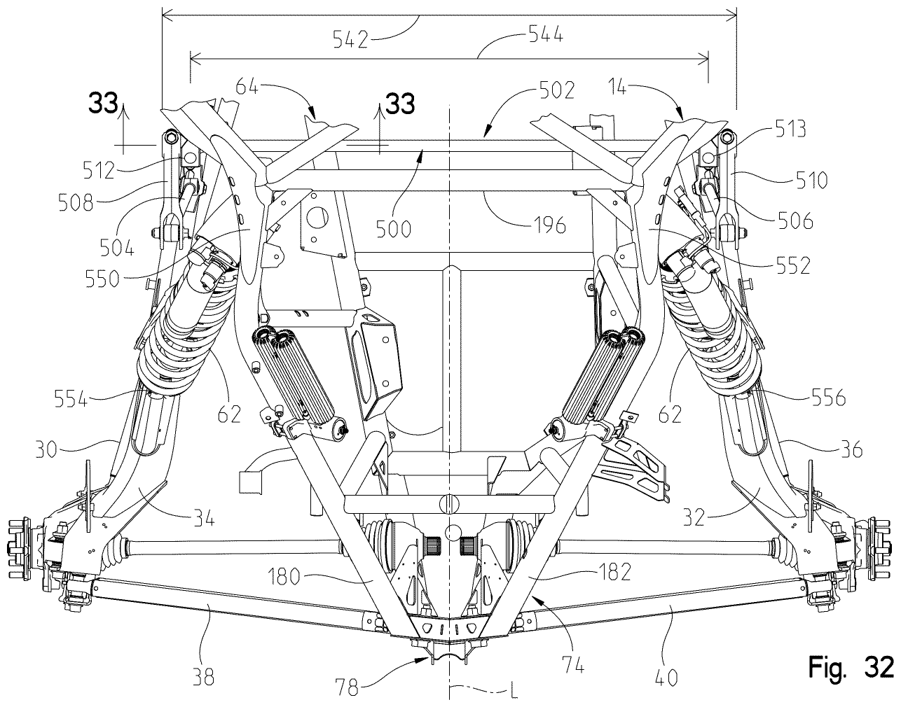

Referring now to FIGS. 32-33, vehicle 2 includes a stabilizer bar assembly 500 coupled between left rear suspension 30 and right rear suspension 32. Stabilizer bar assembly 500 includes a bar member 502, a first link 504 coupled to the left rear suspension 30, a second link 506 coupled to the right rear suspension 32, a first coupler 508 coupled between the first link 504 and the bar member 502, and a second coupler 510 coupled between the second link 506 and the bar member 502. A first mount 512 is coupled to frame 14 on a first side of the longitudinal centerline L (e.g., generally on a left side of the vehicle 2) and a second mount 513 is coupled to frame 14 on a second side of the longitudinal centerline L opposite of the first side (e.g., generally on a right side of the vehicle 2). In embodiments, each of first mount 512 and second mount 513 define an aperture 514 and bar member 502 sits within apertures 514 and bar member 502 is supported by the frame 14 through each of first mount 512 and second mount 513. In embodiments, a bushing or resilient member 516 sits within each aperture 514 and bar member 502 sits within and is supported by each resilient member 516. In embodiments, the first mount 512 is positioned laterally outside of a shock upper mounting point 550 (FIG. 34) of a left shock absorber 62 and the second mount 514 is positioned laterally outside of a shock upper mounting point 552 of a right shock absorber 62. In embodiments, the first mount 512 is positioned laterally intermediate a shock lower mounting point 554 and the shock upper mounting point 550 of a left shock absorber 62 and the second mount 514 is positioned laterally intermediate a shock lower mounting point 556 and the shock upper mounting point 552 of a right shock absorber 62.

Referring still to FIGS. 32-33, bar member 502 may be generally cylindrical with an outer diameter, an inner diameter, and a wall thickness. Bar member 502 includes a first or middle portion 518 and a second or outer portion 524. Outer portion 524 defines a third portion 526 and a fourth portion 528 positioned laterally outwardly from the third portion 526. In embodiments, first portion 518 defines a wall thickness 520 and an outer diameter 522, third portion 526 defines an outer diameter 530 and a wall thickness 532, and fourth portion 528 defines an outer diameter 534 and a wall thickness 536. In embodiments, wall thickness 536 of fourth portion 528 is smaller than wall thickness 532 of third portion 526 and wall thickness 520 of first portion 518 is smaller than wall thickness 532 of third portion 526. In embodiments, outer diameter 522 of first portion 518 is less than outer diameter 530 of third portion 526 and outer diameter 522 of first portion 518 is less than outer diameter 534 of third portion 526.

In embodiments, an outer surface 538 of outer portion 524 defines a plurality of splines (not shown) and an inner surface 540 of first coupler 508 defines a plurality of corresponding splines (not shown) and the splines of the bar member 502 may couple with the splines of the first coupler 508 so first coupler 508 is rotatably coupled to bar member 502. In embodiments, wall thickness 536 of fourth portion 528 may be less than wall thickness 532 of third portion 526 due to reduced stresses experienced at fourth portion 528. Further, wall thickness 520 of middle portion 518 may be less than wall thickness 532 of third portion 526 because greater bending stresses may be experienced by third portion 526 at first mount 512 and aperture 514 and greater torsional stresses may be experienced by middle portion 518 during the movements of stabilizer bar assembly 500. In embodiments, stabilizer bar assembly 500 extends across a width 542 between first coupler 508 and second coupler 510 and 502 is cantilevered between first mount 512 and aperture 514 across a width 544 defined by the distance between first mount 512 and aperture 514. Each of first mount 512 and aperture 514 are respectively positioned toward a lateral outward extent of stabilizer bar assembly 500 to increase the amount of space available for other components (e.g., a cooling system, powertrain, or other vehicle components) toward the middle of the vehicle 2 (e.g., adjacent or closer to longitudinal centerline L). That is, bar member 502 is cantilevered between a point laterally outwardly of shock upper mounting point 550 of the rear left shock absorber 62 and a point outwardly of shock upper mounting point 552 of the rear right shock absorber 62.

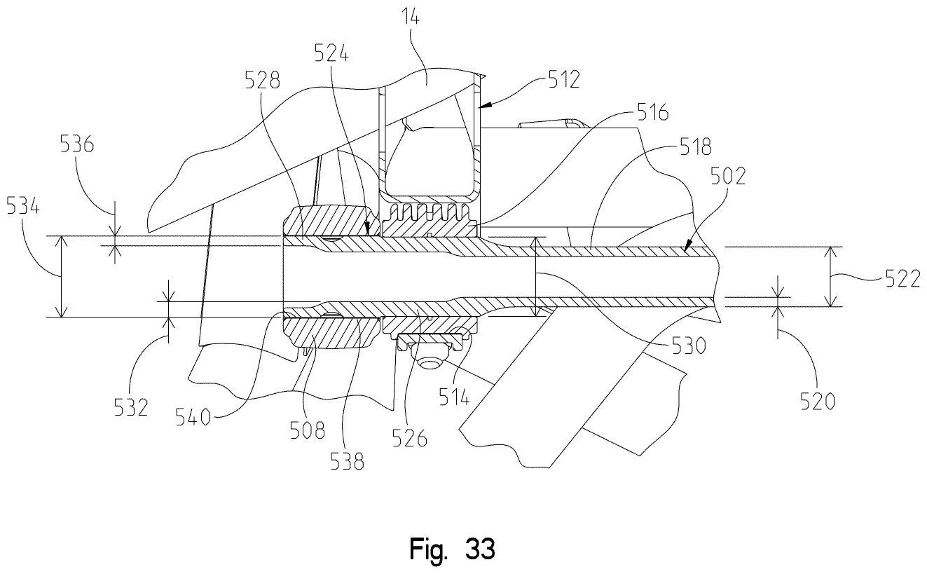

Referring now to FIGS. 34-35, shock absorber 62 extends between upper shock mounting point 550 and lower shock mounting point 552. In embodiments, an eyelet 570 is positioned at an upper extent of shock absorber 62. A mounting member 558 is coupled to each of frame member 180 and cross-member 198. In embodiments, mounting member 558 is a casting defining a body 559 including a first extension 560, a second extension 562 generally parallel to the first extension 560, and a third extension 572 generally perpendicular to each of the first extension 560 and second extension 562. In embodiments, third extension 572 is coupled to each of first extension 560 and second extension 562. In embodiments, each of first extension 560, second extension 562, third extension 572 define a recess 568. In embodiments, first extension 560 defines an aperture 564, second extension 562 defines an aperture 566, and eyelet 570 extends between first extension 560 and second extension 562 and sits within recess 568 and a fastener (not shown) extends through apertures 564, 566 and eyelet 570 about upper shock mounting point 550 and shock absorber 62 is coupled to mounting member 558. In embodiments, third extension 572 defines an aperture 574.

Referring still to FIGS. 34-35, a strap 576 may extend between trailing arm 30 and mounting member 558. Strap 576 may include a buckle 578 defining an aperture 580 and a fastener (not shown) may extend through aperture 580 and aperture 574 to couple strap 576 to mounting member 558. That is, in embodiments, mounting member 558 includes coupling for each of shock absorber 62 and strap 576. In embodiments, strap 576 includes a bottom buckle (not shown) at a bottom extent and the bottom buckle couples to trailing arm 30. In embodiments, strap 576 is a limiter strap and prevents shock absorber 62 from extending beyond a predetermined length, or stroke, which prevents or limits damage to shock absorber 62 during operation of vehicle 2 (e.g., during an airborne event when trailing arms 30, 32 fall under their own weight and shock absorbers 62 are extended to their full length). In embodiments, strap 576 is formed of a resilient material, a high tensile material, or another suitable material.

Still referring to FIGS. 34-35, mounting member 558 and strap 576 are shown relative to a rear shock absorber 62 (e.g., rear left shock absorber 62). In embodiments, each shock absorber (e.g., front right shock absorber 60, front left shock absorber 60, rear right shock absorber 62, rear left shock absorber 62) includes a mounting member 558 and a strap 576. In embodiments, at least one of the shock absorbers 60, 62 includes a mounting member 558 and a strap 576.

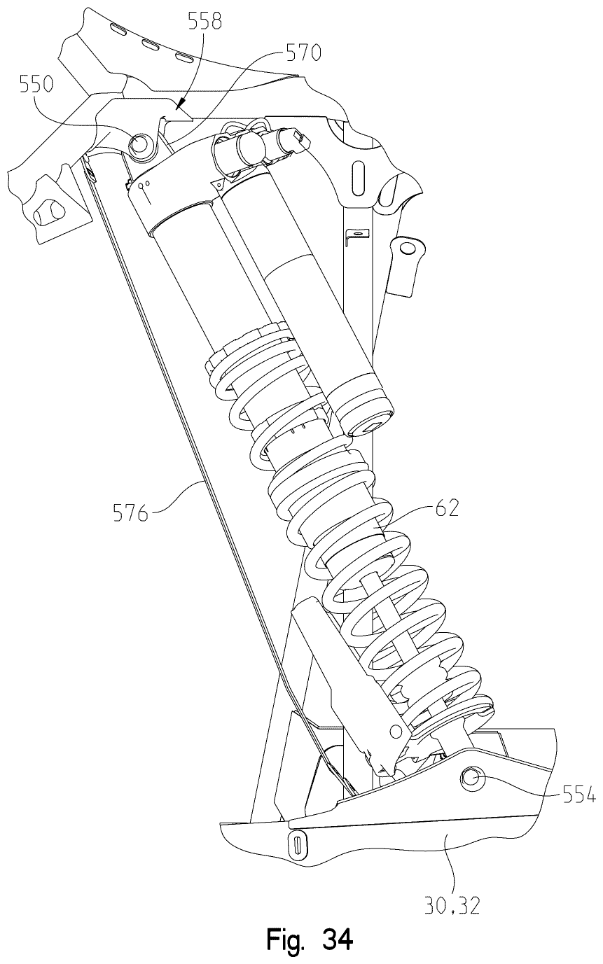

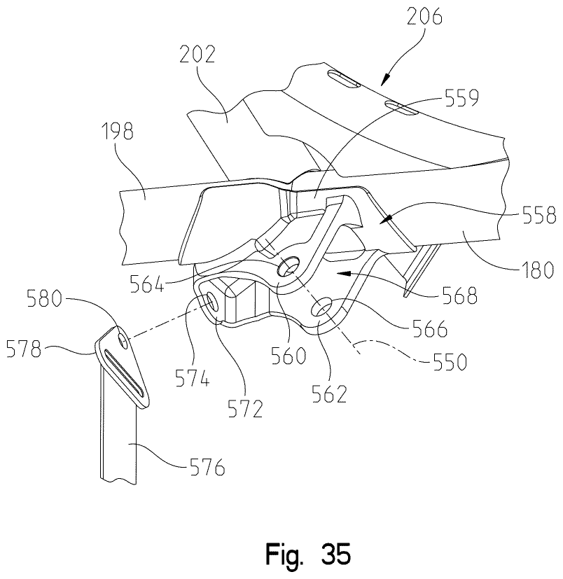

Referring now to FIGS. 36-37, a first bracket 582 is coupled to frame member 180 of rear frame portion 74 and a second bracket 586 is coupled to frame member 182 of rear frame portion 74. First bracket 582 includes a recessed portion or cup 584. Second bracket 586 includes a plate 588 defining a U-shaped aperture 590. A halfshaft (e.g., a spare halfshaft for one or more of halfshafts 234, 236) includes a shaft 592 separated by a pair of boots 593 and a first end 598 and a second end 600. A first nut 596 couples to the first end 598 and a second nut 594 couples to the second end 600.

Still referring to FIGS. 36-37, the spare halfshaft 592 extends between first bracket 582 and second bracket 586. In embodiments, second end 600 is fit into recessed portion 584, and first end 598 is positioned to sit in U-shaped aperture 590. The halfshaft 592 may be pressed toward first bracket 582 and first nut 596 threads onto first end 598 and abuts plate 588 such that halfshaft is coupled between first bracket 582 and second bracket 586 and may be resistant to movement during vehicle operation. However, nut 596 may be removed with a wrench and halfshaft 592 may be removed to replace one of halfshafts 234, 236. In embodiments, nut 594 may sit within recessed portion 584. In embodiments, second end 600 is inserted through cup 584 and nut 594 threads onto second end 600 to secure second end 600 to first bracket 582.

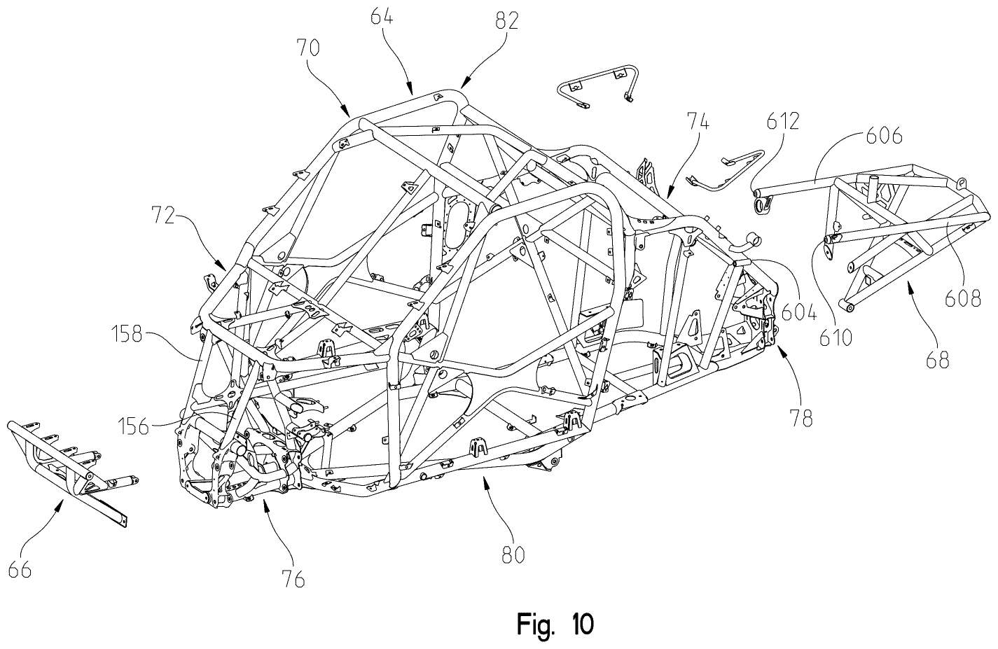

Referring still to FIGS. 36-37, rear frame portion 74 includes a first frame piece 602 coupled to frame member 182 and a second frame piece 604 coupled to frame member 180. In embodiments, each of first frame piece 602 and second frame piece 604 are generally cylindrical. Rear subframe 68 includes a first longitudinally extending frame member 606 including a first end 610 (FIG. 10) and a second longitudinally extending frame member 608 including a second end 612 (FIG. 10). In embodiments, first end 610 extends through first frame piece 602 and second end 612 extends through second frame piece 604. Rear subframe 68 also includes a first generally upstanding frame member 614, a second generally upstanding frame member 616, a third generally upstanding frame member 618, and a fourth generally upstanding frame member 619. In embodiments, each of frame members 614, 616, 618, 619 couple to rear subassembly 78 and rear subframe 68 is coupled to rear frame portion 74. In embodiments, rear subframe 68 includes a frame member 611 extending between longitudinally extending frame members 606, 608. In embodiments, a post 613 extends upwardly from frame member 611 and a tire 615 may be received on post 613. In embodiments, a nut (not shown) may be threaded onto post 613 to secure tire 615 on post 613.

Still referring to FIGS. 36-37, rear subframe 68 may include a first bracket 620 coupled to frame member 606 and a second bracket 624 coupled to frame member 606. First bracket 620 may define an aperture 622 and second bracket 624 may define a recessed portion 626 and a clamp 628. A jack 638 (e.g., a car jack) includes a first portion 640 and a second portion or plate 642. In embodiments, first portion 640 has a complementary shape to aperture 622 and may be received within aperture 622. Plate 642 may have a complementary shape to recessed portion 626 and clamp 628 may be actuated (e.g., threaded, switched, or otherwise engaged) to exert a clamping force between plate 642 and second bracket 624. Jack 638 may be coupled to rear subframe 68 by coupling jack 638 between first bracket 620 and second bracket 624.

Still referring to FIGS. 36-37, rear subframe 68 may include a third bracket 630 and a fourth bracket 634. Third bracket 630 may define an aperture 632 and fourth bracket 634 may define an aperture 636. A control arm 644 (e.g., a spare control arm similar to one or more of control arms 34, 36, 38, 40) includes a first end 646 and a second end 648. In embodiments, the first end 646 is a ball joint and the second end 648 is a ball joint. In embodiments, control arm 644 may be coupled between third bracket 630 and fourth bracket 634. In embodiments, a fastener (not shown, e.g., a bolt) may extend through first end 646 and aperture 636 to couple first end 646 to fourth bracket 634 and a fastener (not shown, e.g., a bolt) may extend through second end 648 and aperture 632 to couple second end 648 to third bracket 630. An operator, passenger, or other service provider may utilize one or more of the spare halfshaft 592, spare tire 615, spare control arm 644, or jack 638 to service vehicle 2, and each of spare halfshaft 592, spare tire 615, spare control arm 644, and jack 638 are readily accessible.

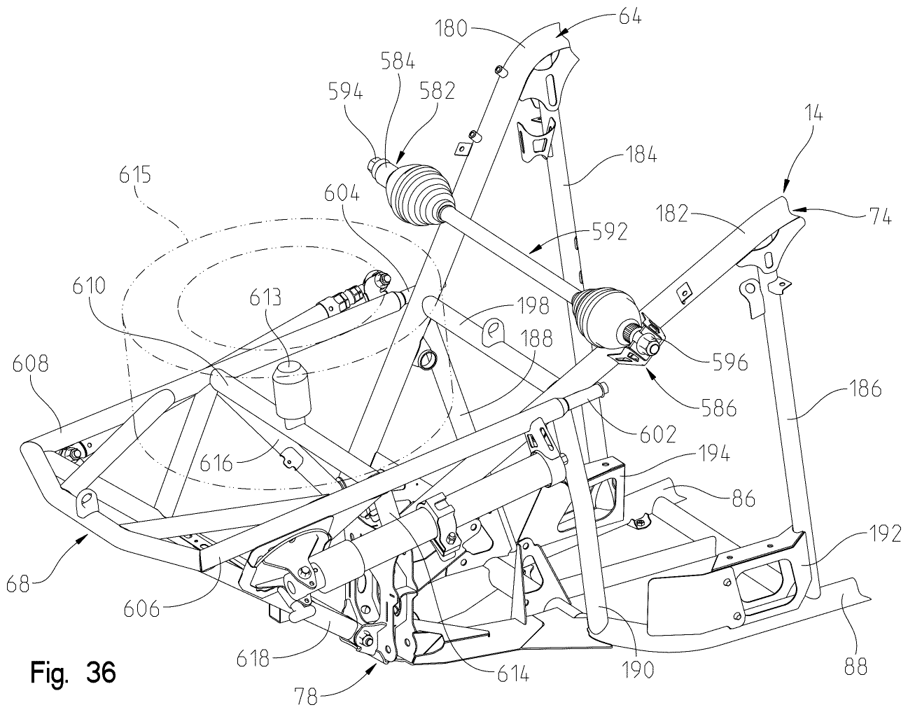

Referring now to FIG. 38, vehicle 2 may not include rear subframe 68, and a plate 680 may be coupled between frame member 180 and frame member 182. In embodiments, a first coupling member 682 couples between frame member 182 and plate 680 and a second coupling member 684 couples between frame member 180 and plate 680. A tub 686 may be coupled to plate 680 and tub 686 includes a first recessed portion 688 and a second recessed portion 690. In embodiments, tub 686 is coupled to rear frame portion 74 or tub 686 is coupled to one or both of frame member 180 and frame member 182. In embodiments, a first tire 692 sits within first recessed portion 688 such that first tire 692 sits about an axis 693 and a second tire 694 sits within second recessed portion 690 such that second tire 694 sits about an axis 695. In embodiments, axes 693, 695 are generally parallel with each other. In embodiments, axes 693, 695 are offset from each other. In embodiments, axes 693, 695 are generally parallel and offset from each other. In embodiments, axis 695 is positioned rearwardly of axis 693 and each of first tire 692 and second tire 694 are generally positioned at a same or similar height. In embodiments, a first strap 696 surrounds first tire 692 to couple first tire 692 to rear frame 74. In embodiments, a second strap 698 surrounds both first tire 692 and second tire 694 to couple second tire 694 to frame 14. In embodiments, each of first strap 696 and second strap 698 includes a plurality of mounting points (e.g., mounting points 700, 702, 704) to couple straps 696, 698 to frame 14.

Still referring to FIG. 38, a first bracket 706 (similar to bracket 620) is coupled to rear frame portion 74 adjacent frame member 180 and a second bracket 708 (similar to bracket 624) is coupled to rear frame portion 74 adjacent frame member 182. In embodiments, a jack (e.g., jack 638) may be coupled between first bracket 706 and second bracket 708, and jack (e.g., jack 638) may be positioned longitudinally forward of tires 692, 694.

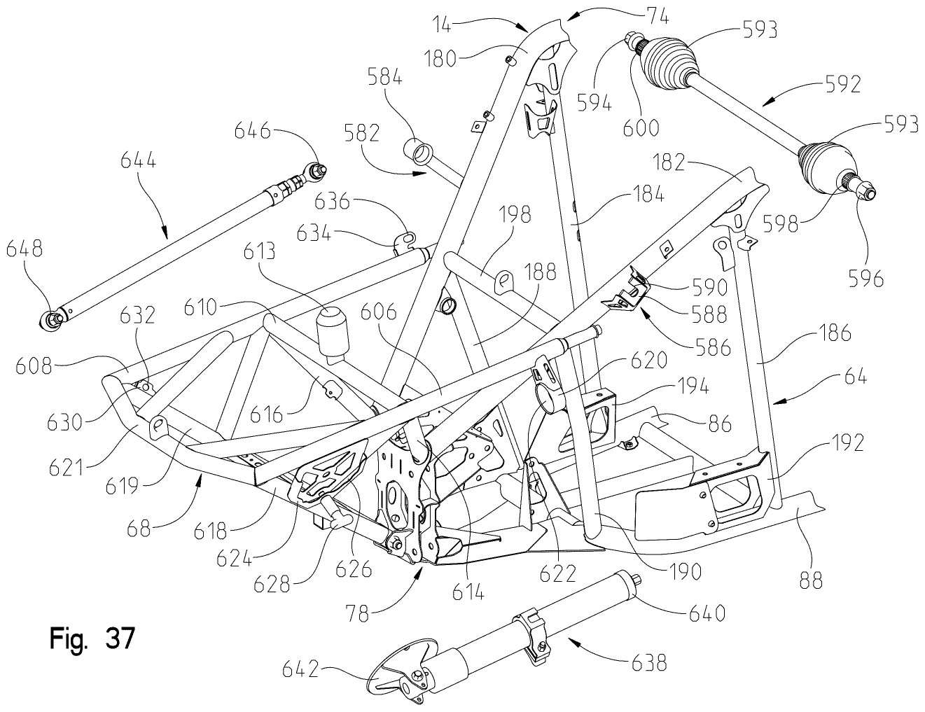

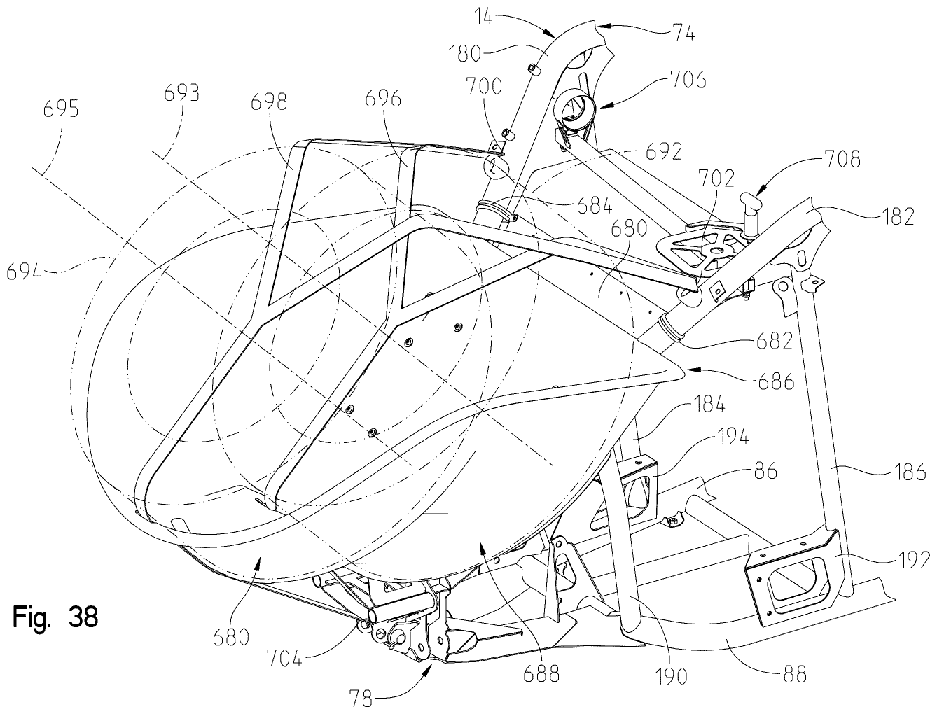

Referring now to FIGS. 39-40, trailing arms 30, 32 may include a first portion 650 and a second portion 652. In embodiments, trailing arm 30 includes a first tab 654 defining an aperture 656 and a second tab 658 defining an aperture 660. Trailing arm 30 supports a hub 676, and a brake disc 674 is coupled to hub 676. In embodiments a brake caliper 380 (or any of brake calipers 376, 378, 380, 382) is operably coupled to brake disc 674.

Still referring to FIGS. 39-40, a plate or shield 662 defines a first aperture 664 and a second aperture 668. In embodiments, plate or shield 662 is generally semi-circular shaped, or arcuately shaped, and first aperture 664 is generally positioned adjacent an upper extent of plate or shield 662 and second aperture 668 is generally positioned adjacent a lower extent of plate or shield 662. A fastener 670 extends through aperture 664 and aperture 656 and a fasteners 672 extends through aperture 668 and aperture 660 to couple shield 662 to trailing arm 30. In embodiments, each trailing arm 30, 32 includes a plate or shield 662. Rocks, sticks, or other debris may be kicked up or otherwise present within the rear of vehicle 2 and may be funneled rearwardly along trailing arm 30, 32, and plate or shield 662 prevents or mitigates rocks, sticks, or other debris from reaching or interfering with brake disc 674, brake caliper 380 (or any of brake calipers 376, 378, 380, 382), or hub 676.

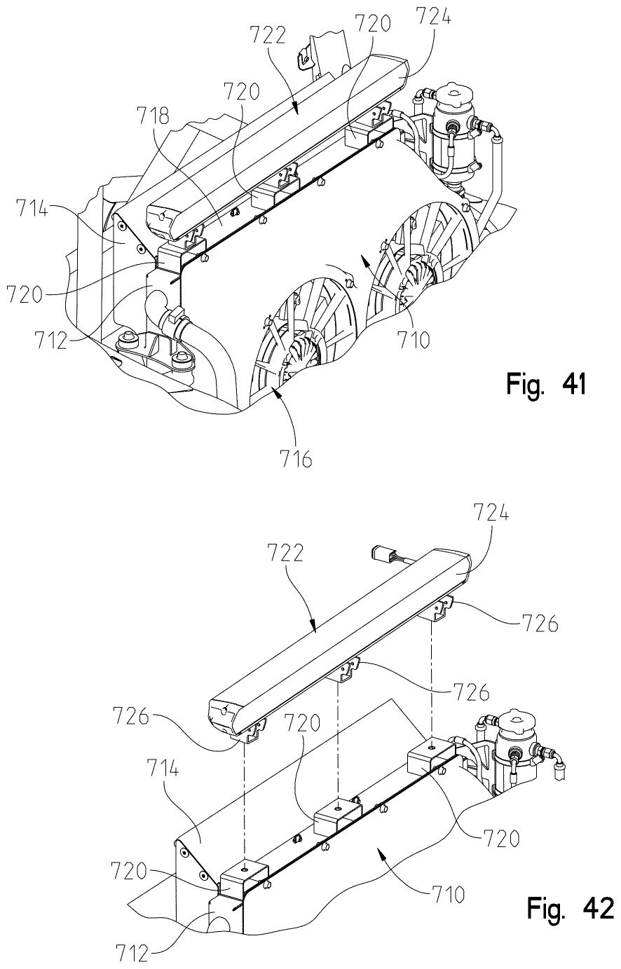

Referring now to FIGS. 41-42, cooling assembly 710 includes a heat exchanger 712 (e.g., a radiator or intercooler) coupled intermediate an intake shroud 714 and a fan assembly 716. In embodiments, heat exchanger 712 includes an upper face 718 and a plurality of mounts 720 are coupled to the upper face 718. In embodiments, mounts 720 are brackets 720.

Referring still to FIGS. 41-42, a light bar or light 722 includes an illumination surface 724 facing generally rearwardly. Light bar 722 includes a plurality of mounting brackets 726 and mounting brackets 726 couple with each of mounts 720 on heat exchanger 712. That is, light bar 722 is a rear facing light, or chase light, and may be used as a brake light, a turn signal, a chase light, or another type of light.

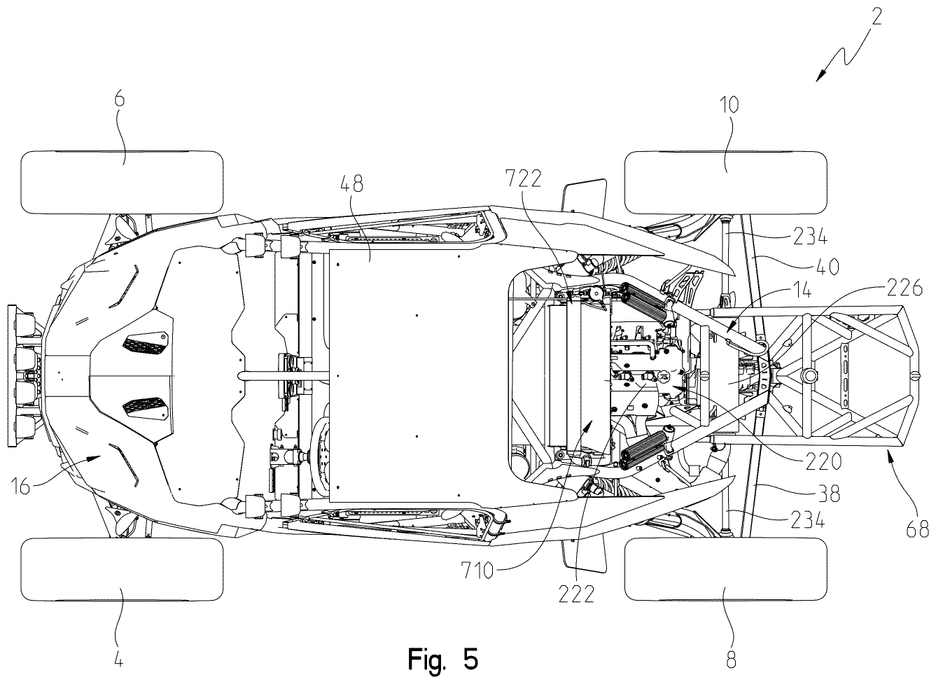

Referring now to FIG. 5, light bar 722 is positioned longitudinally forward of each of ground engaging members 8, 10 and positioned vertically higher than cooling assembly 710. In embodiments, light bar 722 is positioned rearwardly of roof 48. In embodiments, light bar 722 is positioned longitudinally forward of a rearward extent of the prime mover 222. In embodiments, light bar 722 is positioned longitudinally forward of halfshafts 234. In embodiments, light bar 722 is positioned longitudinally forward of each of control arms 38, 40.

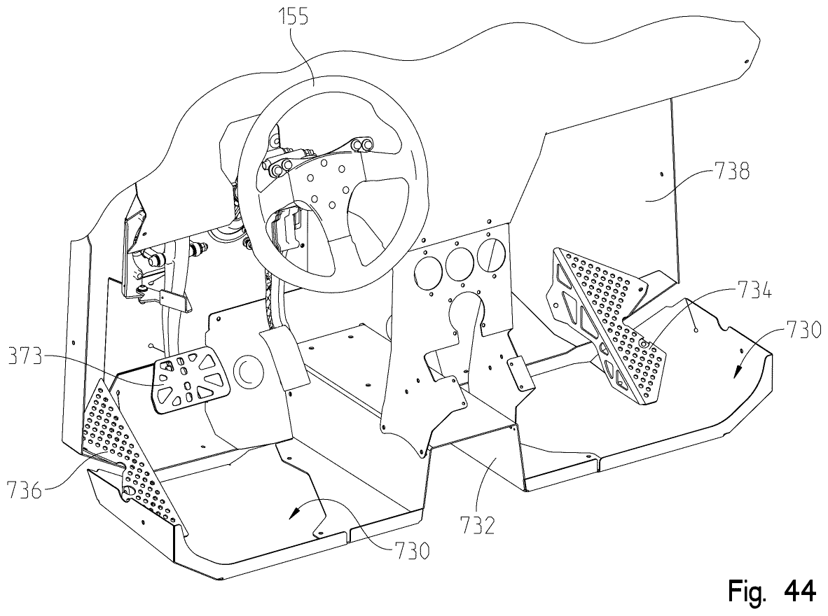

Referring now to FIGS. 43-45, operator area 150 includes a floor 730 which may include a tunnel portion 732. Tunnel portion 732 may house conduits, electrical cables, a drive shaft, or other components. Further, a panel 738 (similar to or the same as front wall 45) is generally vertically extending and separates the operator area 150 from components within front frame portion 72 (e.g., front suspension 18). A first footrest or dead pedal 734 is coupled between floor 130 and panel 738 such that a passenger 461 (FIG. 15) may rest a foot (e.g., right foot) on footrest or dead pedal 734. A second footrest or dead pedal 736 is coupled between floor 130 and panel 738 such that a driver 459 (FIG. 15) may rest a foot (e.g., left foot on footrest or dead pedal 736). In embodiments, it is advantageous to create ergonomic components for driver 459 and passenger 461 to increase comfort during prolonged or difficult trips.

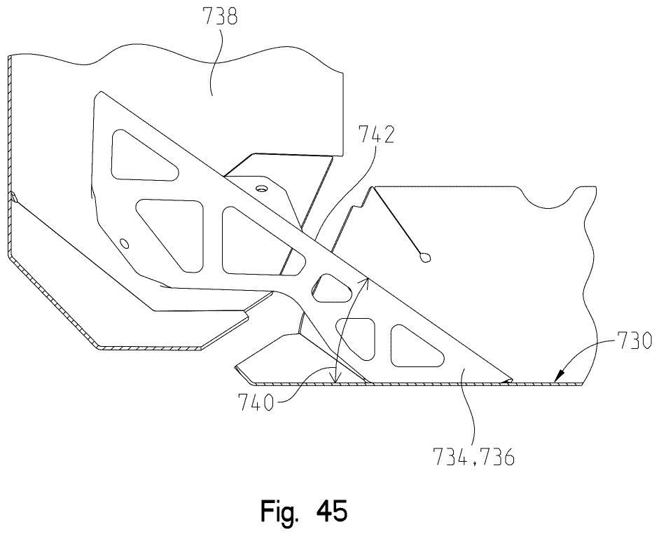

Referring to FIG. 45, each of footrests or dead pedals 734, 736 has an upper surface 742 to receive a foot of passenger or driver, respectively. In embodiments, upper surface 742 is angled relative to floor 730 by an angle 740. In embodiments, angle 740 is between 10-50 degrees. In embodiments, angle 740 is between 20-40 degrees. In embodiments, angle 740 is approximately 30 degrees. In embodiments, angle 740 is approximately 31 degrees.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members;
a frame supported by the plurality of ground engaging members, the frame comprising a front frame portion and a rear frame portion, and wherein the front frame portion comprises a first generally upstanding frame member a second generally upstanding frame member laterally offset from the first generally upstanding frame member;
a powertrain supported by the frame, the powertrain including a prime mover operably coupled to at least one ground engaging member of the plurality of ground engaging members and a drive member operably coupled intermediate the prime mover and the at least one ground engaging member, and the drive member is supported by the front frame portion;
a first suspension coupled intermediate the frame and the at least one ground engaging member;
a second suspension coupled intermediate the frame and a second ground engaging member of the plurality of ground engaging members;
a third suspension coupled between the first suspension and the second suspension; and
wherein the first suspension is supported by the first generally upstanding frame member, the second suspension is supported by the second generally upstanding frame member, the drive member is supported by each of the first generally upstanding frame member and the second generally upstanding frame member, and the third suspension is supported by each of the first generally upstanding frame member and the second generally upstanding frame member.

2. The vehicle of claim 1, further comprising a sleeve coupled to the first generally upstanding frame member, and the third suspension extends through the sleeve.

3. The vehicle of claim 2, wherein the sleeve is coupled to each of the first generally upstanding frame member and the second generally upstanding frame member.

4. The vehicle of claim 2, wherein the third suspension includes a stabilizer bar extending through the sleeve.

5. The vehicle of claim 2, wherein the sleeve is fixedly coupled to each of the first generally upstanding frame member and the second generally upstanding frame member.

6. The vehicle of claim 2, wherein the first generally upstanding member includes a recess and the first suspension sits within the recess, and the recess is positioned vertically lower than the sleeve.

7. The vehicle of claim 1, wherein the frame further includes a third generally upstanding frame member and a fourth generally upstanding frame member, and the third generally upstanding frame member is fixedly coupled to an upper portion of the first generally upstanding frame member and the fourth generally upstanding frame member is fixedly coupled to an upper portion of the second generally upstanding frame member.

8. The vehicle of claim 1, further comprising a bumper operably coupled to each of the first generally upstanding frame member and the second generally upstanding frame member.

9. A vehicle, comprising:
a plurality of ground engaging members;
a frame supported by the plurality of ground engaging members, the frame comprising a front frame portion, the front frame portion including a first upstanding member and a second upstanding member laterally offset from the first upstanding member, a first frame member extending rearwardly from the first upstanding member and a second frame member extending rearwardly from the second upstanding member, and a third frame member extending between the first frame member and the second frame member;
a powertrain supported by the frame, the powertrain comprising a prime mover operably coupled to at least one ground engaging member of the plurality of ground engaging members and a drive member operably coupled between the prime mover and the at least one ground engaging member;
a steering assembly supported by the frame, the steering assembly operably coupled to a first ground engaging member of the plurality of ground engaging members; and
wherein the drive member is supported by each of the first upstanding member, the second upstanding member and the third frame member, and the steering assembly is supported by the third frame member.

10. The vehicle of claim 9, wherein the drive member includes a first mounting collar and a second mounting collar, the third frame member includes a first mounting portion and a second mounting portion, and the first mounting collar is coupled between the first upstanding member and the second upstanding member and the second mounting collar is coupled between the first mounting portion and the second mounting portion.

11. The vehicle of claim 10, wherein the third frame member is a collar that surrounds at least a portion of the drive member.

12. The vehicle of claim 9, wherein the steering assembly includes a steering rack, and the steering rack is supported by the frame through the third frame member.

13. The vehicle of claim 12, wherein the steering rack is positioned rearwardly of the drive member.

14. The vehicle of claim 9, further comprising a suspension member operably coupled between the frame and the first ground engaging member, and the suspension member is operably coupled to the first upstanding member.

15. The vehicle of claim 14, further comprising a bracket coupled to the frame, the bracket positioned rearward of the first upstanding member, and the suspension member is operably coupled to each of the first upstanding member and the bracket.

16. The vehicle of claim 15, wherein the steering rack is positioned longitudinally forward of the bracket.

17. The vehicle of claim 14, wherein the suspension member is a first suspension member, and a second suspension member is operably coupled between the frame and a second ground engaging member, and a stabilizer bar assembly is coupled to each of the first suspension member and the second suspension member, and the stabilizer bar assembly is supported by each of the first upstanding member and the second upstanding member.

18. The vehicle of claim 17, further comprising a sleeve operably coupled to each of the first upstanding member and the second upstanding member, and a member of the stabilizer bar assembly extends through the sleeve.

19. A vehicle, comprising:
a plurality of ground engaging members;
a frame supported by the plurality of ground engaging members, the frame comprising:
a lower frame portion;
a first frame member positioned vertically above the lower frame portion;
a second frame member coupled to the first frame member at a first mounting point and extending generally downwardly from the first frame member;
a third frame member coupled to the first frame member at a second mounting point and extending generally downwardly from the first frame member, the third frame member coupled with the second frame member to form an X shape;
a fourth frame member coupled to the first frame member at a third mounting point forward of the first mounting point and extending generally downwardly, and the fourth frame member coupled with the second frame member; and
a fifth frame member coupled to the first frame member at a fourth mounting point forward of the first mounting point and extending generally downwardly, and the fifth frame member coupled with the third frame member.

20. The vehicle of claim 19, wherein the fourth frame member is coupled to the lower frame portion and the fifth frame member is coupled to the lower frame portion.

21. The vehicle of claim B2, wherein the frame further comprises:
a sixth frame member coupled to the first frame member and extending generally downwardly;
a seventh frame member coupled to the first frame member and extending generally downwardly; and
the second frame member is coupled between the first frame member and the sixth frame member, and the third frame member is coupled between the first frame member and the seventh frame member.

22. The vehicle of claim 21, wherein the second frame member includes a first portion and a second portion, and the first portion is coupled to a first side of the third frame member and the second portion is coupled to a second side of the third frame member opposite the first side.

23. The vehicle of claim 19, wherein one of the second frame member and the fourth frame member includes a scalloped portion and the other of the second frame member and the fourth frame member sits within the scalloped portion.

24. A vehicle, comprising:
a plurality of ground engaging members;
a frame supported by the plurality of ground engaging members, the frame extending along a vehicle centerline;
a first suspension member operably coupled between the frame and a first ground engaging member of the plurality of ground engaging members;
a first shock absorber coupled between the frame at a first mounting point and the second suspension member at a second mounting point;
a second suspension member operably coupled between the frame and a second ground engaging member of the plurality of ground engaging members;
a second shock absorber coupled between the frame at a third mounting point and the second suspension member at a fourth mounting point;
a stabilizer bar assembly coupled between the first suspension member and the second suspension member, the stabilizer bar assembly comprising:
a first mounting member coupled to the frame on a first side of the vehicle centerline and positioned laterally outwardly relative to the first mounting point;
a second mounting member coupled to the frame on a second side of the vehicle centerline opposite the first side and positioned laterally outwardly relative to the third mounting point; and
a stabilizer bar supported by the first mounting member and the second mounting member; and
wherein the stabilizer bar is cantilevered between the first mounting member and the second mounting member.

25. The vehicle of claim 24, wherein the first mounting member is positioned laterally inwardly relative to the second mounting point and the second mounting member is positioned laterally inwardly relative to the fourth mounting point.

26. The vehicle of claim 24, wherein the stabilizer bar defines a first portion defining a first wall thickness and a second portion defining a second wall thickness, and the second wall thickness is less than the first wall thickness.

27. The vehicle of claim 26, wherein the second portion is positioned adjacent a lateral end of the stabilizer bar.

28. The vehicle of claim 24, wherein the stabilizer bar defines a first portion defining a first outer diameter and a second portion defining a second outer diameter, and the first outer diameter is less than the second outer diameter.

29. The vehicle of claim 28, wherein the second portion is positioned adjacent the first mounting member.

30. The vehicle of claim 28, wherein the first portion is positioned laterally intermediate the first mounting member and the second mounting member.

31. The vehicle of claim 24, wherein the stabilizer bar defines an inner portion and an outer portion, and the outer portion defines a plurality of splines and a first wall thickness, and the central portion defines a second wall thickness, and the first wall thickness is less than the second wall thickness.
